(19) United States
(12) Patent Application Publication
(10) Pub. No.: US 2026/0111811 A1
(43) Pub. Date: Apr. 23, 2026

(54) WORKSPACE AND NETWORK MANAGEMENT BASED ON OCCUPANCY DETECTION

(71) Applicant: Cisco Technology, Inc., San Jose, CA (US)

(72) Inventors: William Sterling Alexander, Raleigh, NC (US); Cecilia Rose Mapes, Durham, NC (US); Ruth Grace Pavoor, Cary, NC (US); Rajesh Ramesh Patwardhan, Cary, NC (US)

(21) Appl. No.: 18/973,625

(22) Filed: Dec. 9, 2024

Related U.S. Application Data
(60) Provisional application No. 63/708,370, filed on Oct. 17, 2024.

(51) Int. Cl. G06Q 10/0631; G06V 20/52; G06V 40/16

(52) U.S. Cl. CPC G06Q 10/063114; G06V 20/52; G06V 40/172

(57) ABSTRACT

Techniques are provided for performing one or more network management actions or one or more workspace management actions. In one embodiment, a computer-implemented method includes detecting that a person has occupied a workspace, determining that the workspace is no longer occupied by the person, and upon determining that the workspace is no longer occupied by the person, using the one or more sensors for detecting one or more objects brought by the person to the workspace. The computer-implemented method includes upon detecting the one or more objects while the workspace remains unoccupied, recording a first timestamp, and comparing a duration of unoccupancy of the workspace since the first timestamp to a maximum unoccupancy duration. The computer-implemented method further includes performing one or more network management actions or one or more workspace management actions in response to the duration of unoccupancy exceeding the maximum unoccupancy duration.

### CROSS-REFERENCE TO RELATED APPLICATION

The application claims the benefit of priority under 35 U.S.C. § 119(e) to U.S. Provisional Application No. 63/708,370, filed on Oct. 17, 2024, which is hereby incorporated by reference in its entirety.

### TECHNICAL FIELD

The present disclosure relates to generating one or more workspace and/or network management actions based on an occupancy status of a workspace.

### BACKGROUND

Many institutions (companies, libraries, educational institutions, etc.) leverage workspace sharing or hot desking to encourage collaboration, reduce cost, and increase space efficiency. While these workspace management solutions provide enhanced flexibility and productivity, institutions are confronted with the issue of “workspace camping” or “workspace squatting,” which refers to individuals using shared workspaces intended for short-term occupancy as their personal workspaces. These individuals often passively occupy the workspace by leaving their personal belongings in the workspace without physically occupying it. For example, an individual may enter a workspace and place their personal belongings (e.g., laptop, jacket, bag, etc.) there, then leave the workspace to perform other tasks (e.g., grab lunch, attend a meeting, etc.). The passively occupied workspaces become idle yet remain unavailable to others, thus creating significant bottlenecks in workspace management. Therefore, it is desirable to leverage person detection, object detection, and/or device proximity/pairing information to detect passive occupancy of a workspace and take appropriate workspace/network management actions in a timely manner.

### BRIEF DESCRIPTION OF THE DRAWINGS

FIG. 1 is a block diagram illustrating a system for performing one or more network management actions or one or more workspace management actions, according to an example embodiment.

FIG. 2A is a block diagram illustrating an arrangement for managing a workspace system, according to an example embodiment.

FIG. 2B is a diagram illustrating an image of a workspace captured by an optical sensor at a time T1, according to an example embodiment.

FIG. 2C is a diagram illustrating an image of the workspace captured by the optical sensor at a time T2, which occurs after T1, according to an example embodiment.

FIG. 2D is a diagram illustrating an image of the workspace captured by the optical sensor at a time T3, which occurs after T2, according to an example embodiment.

FIG. 3A is a block diagram illustrating a flow for determining one or more network management actions or one or more workspace management actions, according to an example embodiment.

FIG. 3B is a diagram illustrating a workspace utilization metrics dashboard, according to an example embodiment.

FIG. 3C is a diagram illustrating a graphical user interface displaying a workspace management dashboard, according to an example embodiment.

FIG. 4A is a block diagram illustrating a flow for classifying a workspace type or workspace state via a large language model (LLM), according to an example embodiment.

FIG. 4B is a block diagram illustrating an example processing flow providing an LLM-based analysis output to a prompt, according to an example embodiment.

FIG. 4C is a block diagram illustrating an example processing flow for providing an LLM-based analysis output to a revised prompt, according to an example embodiment.

FIG. 4D is a block diagram illustrating an example processing flow providing an LLM-based analysis output to a prompt, according to an example embodiment.

FIG. 4E is a block diagram illustrating an example processing flow providing an LLM-based analysis output to a revised prompt, according to an example embodiment.

FIG. 5 is a block diagram illustrating a processing flow for generating outputs describing a workspace via a LLM, according to an example embodiment.

FIGS. 6A-6B is an operational sequence diagram for detecting passive occupancy of a workspace, according to an example embodiment.

FIGS. 7A-7C is an operational sequence diagram for providing a notification in response to detected passive occupancy of a workspace, according to an example embodiment.

FIG. 8 is a flow diagram illustrating a method for performing one or more network management actions or one or more workspace management actions, according to an example embodiment.

FIG. 9 is a hardware block diagram of a computing device configured to perform one or more techniques presented herein.

### DETAILED DESCRIPTION

### Overview

Techniques are provided for performing one or more network management actions or one or more workspace management actions in response to detecting passive occupancy of a workspace. In one embodiment, a computer-implemented method includes using one or more sensors positioned to capture activity in a workspace, detecting, via a person detection model that operates on output from the one or more sensors, that a person has occupied a workspace. The computer-implemented method includes determining, with the one or more sensors, that the workspace is no longer occupied by the person, and upon determining that the workspace is no longer occupied by the person, using the one or more sensors for detecting, via an object detection model, one or more objects brought by the person to the workspace. The computer-implemented method includes upon detecting the one or more objects while the workspace remains unoccupied, recording a first timestamp, and comparing a duration of unoccupancy of the workspace since the first timestamp to a maximum unoccupancy duration. The computer-implemented method further includes performing one or more network management actions or one or more workspace management actions in response to the duration of unoccupancy exceeding the maximum unoccupancy duration.

### EXAMPLE EMBODIMENTS

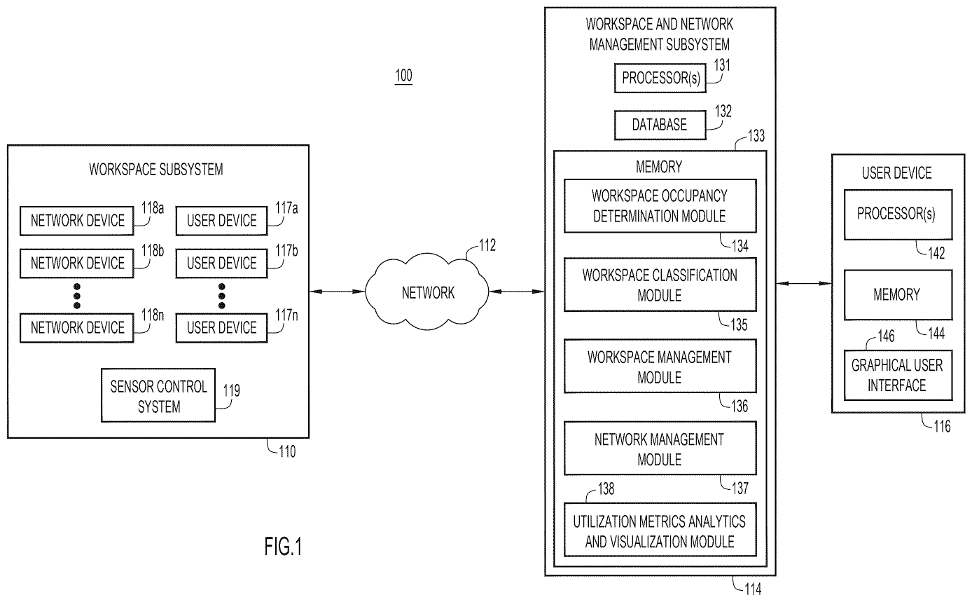

Reference is first made to FIG. 1, for a description of a block diagram illustrating a system 100 for performing one or more network management actions or one or more workspace management actions, according to an example embodiment. The system 100 includes a workspace subsystem 110, a network 112, a workspace and network management subsystem 114, and a user device 116. The workspace subsystem 110 is configured to communicate with the workspace and network management subsystem 114 via the network 112. The workspace subsystem 110 communicates data collected from or associated with a workspace (e.g., sensor data, device pairing/usage data, device proximity data, etc.). Based on an analysis of the data transmitted by the workspace subsystem 110, the workspace and network management subsystem 114 is configured to generate a plurality of outputs, including workspace occupancy status and utilization metrics. The plurality of outputs is transmitted to the user device 116 for display and/or further processing. Further, the workspace and network management subsystem 114 is configured to communicate one or more workspace management actions and/or one or more network management actions to the workspace subsystem 110 via the network 112.

The workspace subsystem 110 includes a plurality of user devices 117a, 117b, . . . , 117n (also collectively denoted 117a-n), a plurality of network devices 118a, 118b, . . . , 118n (also collectively denoted 118a-n), and a sensor control system 119 positioned within or around the workspace (e.g., room, desk, etc.) to capture one or more activities in the workspace. The notation “a-n” denotes that a number is not limited, can vary widely, and depends on a particular use case scenario. The user devices 117a-n, having connectivity to the network 112, may be used by one or more users in a workspace. The user devices 117a-n may include a mobile phone, a tablet, a laptop, etc. The network devices 118a-n may include a router, a modem, a switch, a gateway, etc. through which network traffic may travel. For example, one or more network devices 118a-n may enable communication between the user devices 117a-n and the network 112. The workspace subsystem 110 further includes a sensor control system 119 configured to manage a plurality of sensors in or around the workspace. Further aspects associated with the sensor control system 119 will be described below.

The network 112 may include a local area network (LAN), a wide area network (WAN) such as the Internet, or a combination thereof, and includes wired, wireless, or fiber optic connections, with numerous network devices through which network traffic may travel. For example, the workspace subsystem 110 may communicate with the workspace and network management subsystem 114 through the Internet.

The workspace and network management subsystem 114 includes one or more processors 131, a database 132, and a memory 133. The one or more processors 131 are configured to perform one or more operations of the workspace and network management subsystem 114. The database 132 is configured to store one or more data (e.g., workspace occupancy status), metadata (e.g., workspace identifier), or other information associated with the workspace. The memory 133 includes instructions for various software programs/modules to be executed by the one or more processors 131 to carry out certain aspects of the techniques presented herein. For example, the memory 133 includes instructions for a workspace occupancy determination module 134, a workspace classification module 135, a workspace management module 136, a network management module 137, and a utilization metrics analytics and visualization module 138.

The workspace occupancy determination module 134 is configured to determine an occupancy status of the workspace based on workspace state data, which includes sensor data (e.g., images, sound, etc.), a workspace availability indicator, a device pairing status, device usage information, proximity pairing information, one or more outputs generated by an object detection model, a person detection model, and/or a face recognition algorithm, workspace layout, and any other data that describes a characteristic or state of the workspace. For example, the workspace occupancy determination module 134 may determine the occupancy status as actively occupied, passively occupied, or unoccupied. A workspace may be considered actively occupied when it is occupied by one or more entities (e.g., a person). A workspace may be considered passively occupied when the one or more entities no longer occupy the workspace, but one or more objects brought by the one or more entities into the workspace remain in the workspace. A workspace may also be considered passively occupied when the one or more entities no longer occupy the workspace, but still maintain an active session in the now unoccupied workspace as indicated in workspace booking data, device sign-in data, etc. A workspace may be considered unoccupied when it is not occupied by one or more entities (e.g., a person). The occupancy status of the workspace may further include information on occupant count, whether the occupancy is scheduled, and any other information that describes the nature of the occupancy. Further aspects associated with the workspace occupancy determination module 134 will be described below.

The workspace classification module 135 is configured to determine a workspace type of the workspace. For example, the workspace classification module 135 may, via a workspace classification model, determine the workspace is a meeting room, a desk, a “huddle” space, a “focus” space, or another type of workspace. A “huddle” space may be a meeting room intended for small group meetings (e.g., a gathering with two or three people) while a “focus” space may be a small study room or phone room that can accommodate one or two people. The workspace classification model may generate one or more classifications of the workspace based on all or a subset of the workspace state data. Further aspects associated with the workspace classification model will be described below.

The workspace management module 136 is configured to determine one or more workspace management actions based on the occupancy status and/or the classification of the workspace. Each type of workspace is associated with an occupancy policy describing one or more rules associated with workspace and/or network usage. One or more workspace management actions may be taken when the occupancy status violates the occupancy policy. The one or more workspace management actions may control and/or manage the user devices 117a-n. The network management module 137 is configured to determine one or more network management actions based on the occupancy status and/or the classification of the workspace. One or more network management actions may be taken when the occupancy status violates the occupancy policy. The one or more network management actions may control and/or manage the network devices 118a-n. Further aspects associated with the one or more workspace management actions and one or more network management actions will be described below.

The utilization metrics analytics and visualization module 138 is configured to generate data analytics (e.g., summaries, forecasts, predictions, estimations, etc.) based on workspace utilization metrics. The data analytics may be generated using any suitable technique or model, such as artificial intelligence/machine learning, statistical analysis, etc. The utilization metrics analytics and visualization module 138 is further configured to generate reports and/or visualizations of the generated data analytics that may be provided as output to the user.

The user device 116 includes one or more processors 142, a memory 144, and a graphical user interface 146. The memory 144 includes instructions for various software programs/modules to be executed by the one or more processors 142 to carry out certain aspects of the techniques presented herein. The graphical user interface 146 displays one or more reports and/or visualizations generated by the utilization metrics analytics and visualization module 138 to the user. Further, the graphical user interface 146 renders modifications to the displayed information based on input(s) received from the user and/or based on data received from the utilization metrics analytics and visualization module 138.

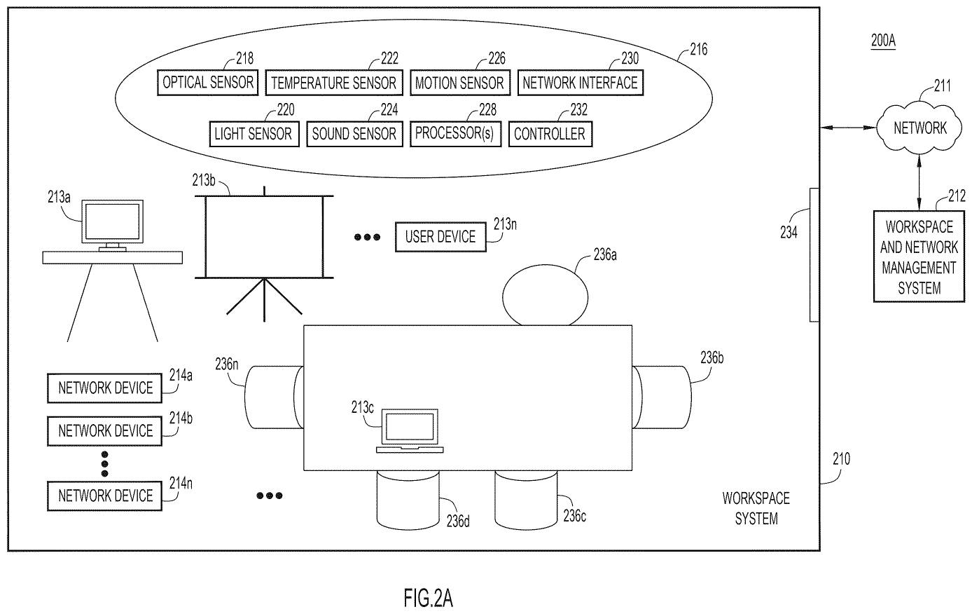

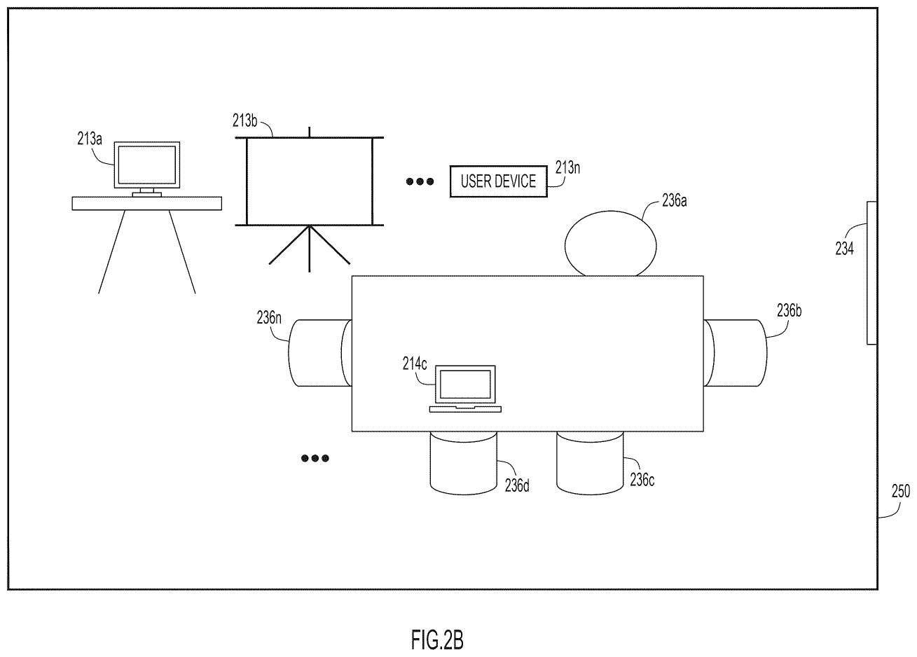

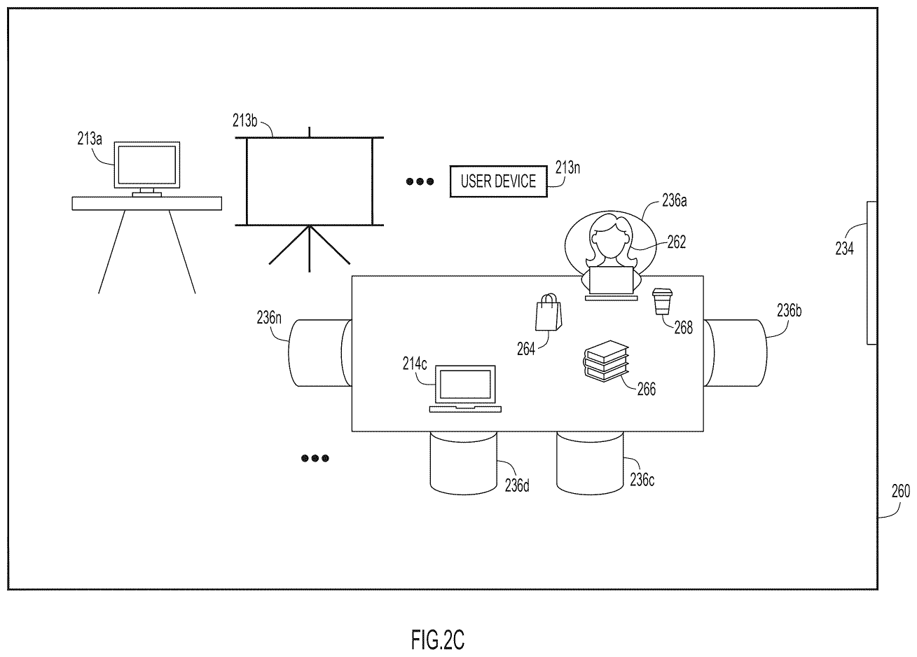

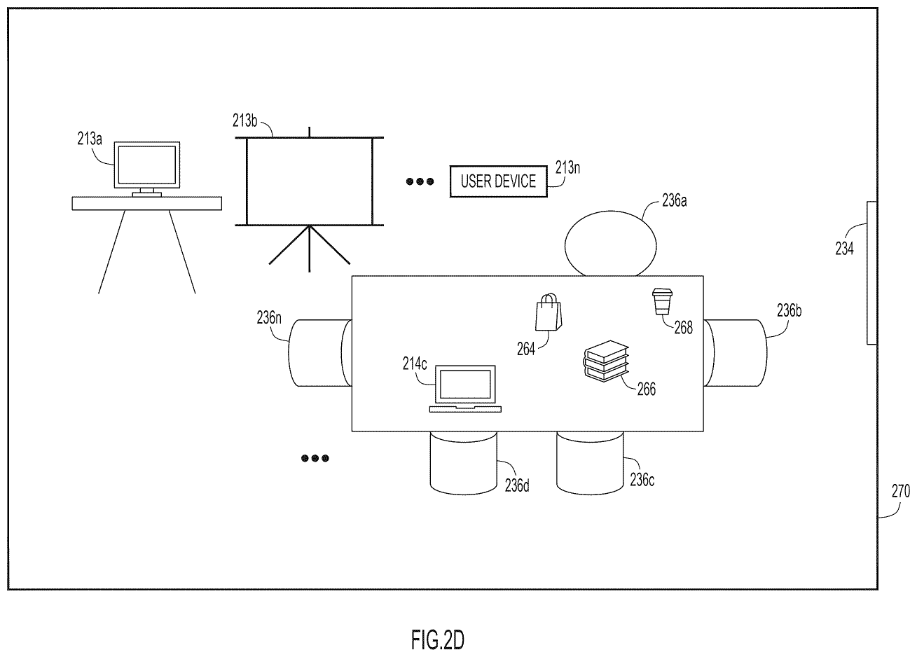

FIG. 2A is a block diagram illustrating an arrangement 200A for managing a workspace system, according to an example embodiment. The arrangement 200A includes a workspace system 210, a network 211, and a workspace and network management system 212. The workspace system 210 communicates data collected from or associated with a workspace (e.g., sensor data, device pairing/usage data, device proximity data, etc.) to the workspace and network management system 212. Based on an analysis of the data transmitted by the workspace system 210, the workspace and network management system 212 is configured to generate a plurality of outputs, including workspace occupancy status and utilization metrics. The workspace and network management system 212 is configured to communicate one or more workspace management actions and/or one or more network management actions to the workspace system 210 via the network 211. The workspace and network management system 212 generates the one or more workspace management actions and/or one or more network management actions in substantially the same manner described above.

The network 211 may include a local area network (LAN), a wide area network (WAN) such as the Internet, or a combination thereof, and includes wired, wireless, or fiber optic connections, with numerous network devices through which network traffic may travel. For example, the workspace system 210 may communicate with the workspace and network management system 212 through the Internet.

The workspace system 210 includes a plurality of user devices 213a, 213b, 213c, . . . , 213n (also collectively denoted 213a-n), a plurality of network devices 214a, 214b, 214c, . . . , 214n (also collectively denoted 214a-n), and a sensor control system 216 positioned within or around the workspace (e.g., room, desk, etc.) to capture one or more activities in the workspace. The notation “a-n” denotes that a number is not limited, can vary widely, and depends on a particular use case scenario. For example, the workspace may be an enclosed space (e.g., a room) or an open space (e.g., a desk or a plurality of desks). The sensor control system 216 for an enclosed space may be positioned within the workspace. The sensor control system 216 for an open space may be positioned within a perimeter around the workspace such that sensor data of activities in the workspace may be captured.

The user devices 213a-n, having connectivity to the network 211, may be used by one or more users in the workspace. The user devices 213a-n may include a mobile phone, a tablet, a laptop, etc. By way of example, the user device 213a may be desktop computer, the user device 213b may be an interactive display and collaboration device, and the user device 213c may be a laptop. The network devices 214a-n may include a router, a modem, a switch, a gateway, etc. through which network traffic may travel. For example, one or more network devices 214a-n may enable communication between the user devices 213a-n and the network 211.

The sensor control system 216 includes a plurality of sensors configured to capture one or more activities in the workspace. For example, the sensor control system 216 includes an optical sensor 218, a light sensor 220, a temperature sensor 222, a sound sensor 224, and a motion sensor 226. The sensor control system 216 may include additional sensors suitable for capturing activity data not illustrated in FIG. 2A. For example, the sensor control system 216 may include one or more optical sensors in addition to the optical sensor 218. The optical sensor 218 may take the form of a video camera that is configured to capture one or more images and/or video footage of the workspace. The light sensor 220 is configured to detect light in the workspace and measure information such as intensity, frequency, and/or wavelength of light. The temperature sensor 222 is configured to detect and measure the temperature of an entity/object in the workspace. The sound sensor 224 is configured to detect sound waves in the workspace. The motion sensor 226 is configured to detect and measure movement in the workspace.

The sensor control system 216 further includes one or more processors 228, a network interface 230, and a controller 232. The one or more processors 228 are configured to perform one or more operations of the sensor control system 216. For example, the one or more processors 228 are configured to process sensor data captured by the plurality of sensors in the sensor control system 216. The network interface 230 enables communications between the sensor control system 216 and the network 211 to transmit the sensor data to the workspace and network management system 212. Based on the transmitted sensor data, the workspace and network management system 212 generates the one or more workspace management actions and/or one or more network management actions in substantially the same manner described above. The workspace and network management system 212 communicates the one or more workspace management actions configured to manage the plurality of sensors to the sensor control system 216 via the network 211. The controller 232 is configured to manage the plurality of sensors based on the one or more workspace management actions. For example, the controller 232 may enable the optical sensor 218 to implement a specific workspace management action (e.g., capturing images of the workspace at a specific interval).

The workspace system 210 further includes an entrance 234 (e.g., a door) and a plurality of seating devices 236a, 236b, 236c, 236d, . . . , 236n (also collectively denoted 236a-n). Although the workspace represented by the workspace system 210 is an enclosed space including the entrance 234, it should be understood that the workspace may be an open space (e.g., a desk) without an entrance. Further, it should be understood that the number of seating devices in each workspace differs based on occupancy capacity and/or workspace type.

With continued reference to FIG. 2A, FIG. 2B is a diagram illustrating an image 250 of a workspace captured by the optical sensor 218 at a time T1, according to an example embodiment. The image 250 may be a baseline image of the workspace when the workspace is unoccupied. For example, the image 250 includes the user devices 213a-n, the entrance 234, and the seating devices 236a-n, but does not include a human occupant.

With continued reference to FIG. 2A and FIG. 2B, FIG. 2C is a diagram illustrating an image 260 of the workspace captured by the optical sensor 218 at a time T2, which occurs after T1, according to an example embodiment. The image 260 may be an image of an actively occupied workspace. For example, the image 260 includes the user devices 213a-n, the entrance 234, and the seating devices 236a-n. The image 260 further includes a person 262 and an object 264, an object 266, and an object 268. Each of the object 264, 266, and 268 may be an object brought by the person 262 into the workspace. For example, the person 262 may bring objects such as bags, books, cups, etc. to the workspace. It should be understood that the number of objects the person 262 may bring into a workspace differs based on individual preference and/or need.

With continued reference to FIGS. 2A-2C, FIG. 2D is a diagram illustrating an image 270 of the workspace captured by the optical sensor 218 at a time T3, which occurs after T2, according to an example embodiment. The image 270 may be an image of a passively occupied workspace. For example, the image 260 includes the user devices 213a-n, the entrance 234, and the seating devices 236a-n. The image 260 further includes the object 264, the object 266, and the object 268, but no longer includes the person (e.g., the person 262) who previously occupied the workspace at T2. The image 270 provides an illustration of a passively occupied workspace, wherein the person no longer physically occupies the workspace, but their personal belongings (e.g., the object 264, 266, 268, etc.) continue to occupy the workspace.

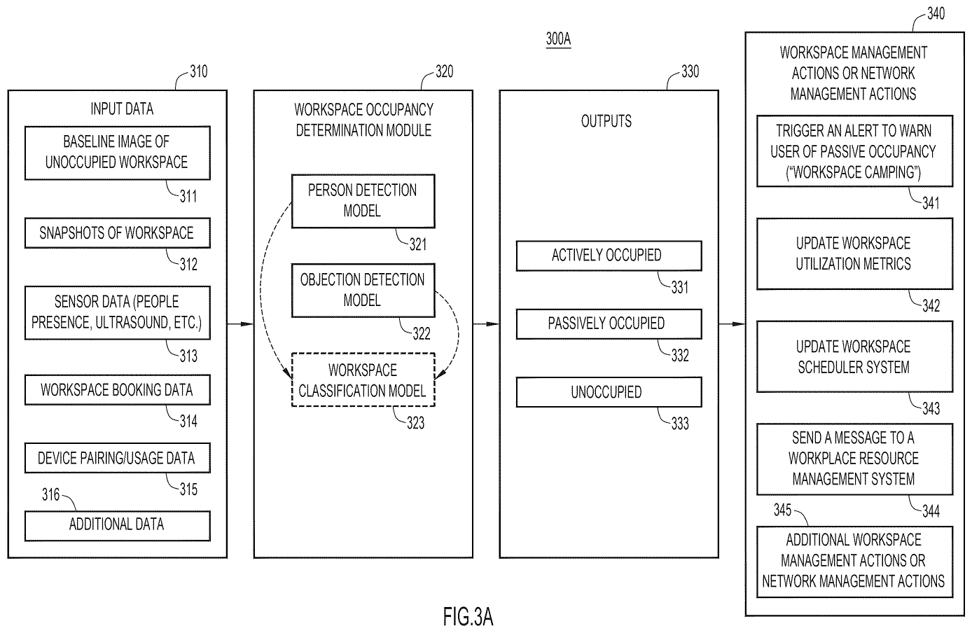

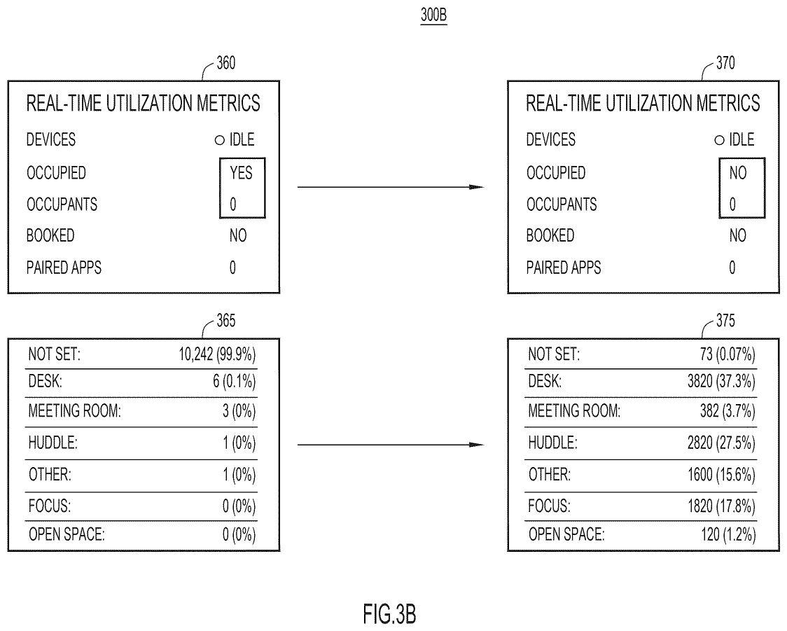

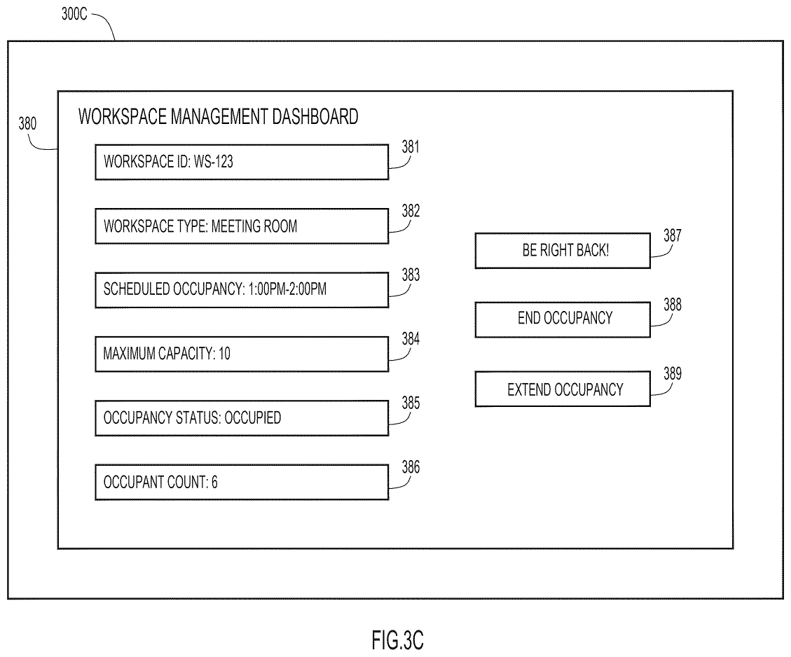

FIG. 3A is a block diagram illustrating a processing flow 300A for determining one or more network management actions or one or more workspace management actions, according to an example embodiment. The processing flow 300A involves capturing input data 310, which describes one or more characteristics or states of the workspace and/or information indicating the user has occupied another workspace different from the workspace being evaluated. The input data 310 may include a baseline image of an unoccupied workspace 311, snapshots of the workspace captured and recorded at various timestamps 312, sensor data 313 (e.g., people presence, ultrasound, etc.), workspace booking data 314, device pairing/usage data 315, and additional data 316. In certain embodiments, the baseline image of an unoccupied workspace 311 and/or the snapshots of the workspace captured and recorded at various timestamps 312 may be obtained from video footage captured via an optical sensor that takes the form of a video camera. The additional data 316 may include one or more of a workspace availability/use indicator, workspace capacity information, occupancy state indicator, proximity pairing information, Wi-Fi® wireless local area network (WLAN) proximity information, calendaring data, hot desk sign in data, meeting attendance information (e.g., the user is in the roster list of another meeting/call), one or more outputs generated by an object detection model, a person detection model, and/or a face recognition algorithm, workspace layout, equipment usage data, and any other data that provides information on a characteristic or state of the workspace or a physical presence of the user. The additional data 316 may further include a new baseline image of a workspace after a user has completed their occupancy but before another user enters the workspace. Further, a new baseline image may be captured after one or more events causing changes to the workspace. For example, after a workspace is transformed from one workspace type (e.g., classroom) to another workspace type (e.g., conference room), a new baseline image of the workspace may be captured.

The input data 310 is provided as input to a workspace occupancy determination module 320. The workspace occupancy determination module 320 may be implemented using a combination of hardware and software. The workspace occupancy determination module 320 includes a person detection model 321 and an object detection model 322. The person detection model 321 is configured to detect one or more people in the workspace based on all or a subset of the input data 310. The object detection model 322 is configured to detect one or more objects in the workspace based on all or a subset of the input data 310.

In certain embodiments, the workspace occupancy determination module 320 may optionally include a workspace classification model 323. The workspace classification model 323 is configured to determine a workspace type and/or capacity of the workspace based on all or a subset of the input data 310. For example, based on the baseline image of an unoccupied workspace 311 or a new baseline image of a workspace, the workspace classification model 323 may determine the workspace is a meeting room, a desk, a “huddle” space, a “focus” space, or another type of workspace. In certain embodiments, in addition to all or a subset of the input data 310, the workspace classification model 323 may optionally take as input one or more outputs generated by the person detection model 321 and/or by the object detection model 322 to generate workspace classification outputs.

The person detection model 321, object detection model 322, and/or workspace classification model 323 may include one or more of a computer vision model, a machine learning model, a statistical model, or any other suitable model. Examples of machine learning models may include neural networks (e.g., convolutional neural network, recurrent neural network, etc.), large language models (e.g., transformer-based models), etc. The person detection model 321, object detection model 322, and workspace classification model 323 may be trained, optimized, and/or fine-tuned via any suitable technique (e.g., supervised or unsupervised learning, transfer learning, reinforcement learning, etc.).

In certain embodiments, an administrator may leverage an intelligent workspace classification process to manage an institution (e.g., a large office building with hundreds or thousands of workspaces). Data collection may be triggered to determine which workspaces within the building are missing metadata (e.g., workspace type, workspace capacity, privacy wall, etc.). Then, the administrator may be prompted to initiate an intelligent workspace classification process to categorize the workspaces and obtain corresponding capacity information. The intelligent workspace classification process may be manually triggered or initiated during device registration/wizard set up, when a workspace is first empty (based on people count), or outside of office hours. Upon initiation, data associated with the workspace, such as the input data 310, is collected from user or network devices in the workspace.

The intelligence workspace classification process may be implemented via the workspace classification model 323 including one or more LLMs (e.g., multi-model LLM) and retrieval-augmented generation (RAG) frameworks. The RAG frameworks may be applied to device information and baseline image input data for matching workspaces and workspace types. The workspace classification model 323 may also utilize workspace sizing estimates obtained from device cameras.

The workspace classification model 323 takes as inputs a prompt provided by a user at a user device and an image of a workspace captured by one or more user devices and/or one or more sensors located within or near the workspace. For example, the prompt may instruct the workspace classification model 323 to provide a workspace type as output. Based on the inputs, the workspace classification model 323 generates a workspace type for the workspace displayed in the image. Based on one or more outputs of the workspace classification model 323, workspace type information in a workspace and network management system, workspace scheduler, utilization metric dashboard, etc. may be set or updated automatically through a data update or icon update.

In another example, the prompt may specify parameters to instruct the workspace classification model 323 to provide workspace capacity along with workspace type. The workspace classification model 323 may include an LLM that utilizes a combination of object detection (e.g., to identify and count chairs), a room layout analysis (e.g., to identify enclosed vs. open spaces), device data (e.g., to identify which workspace to prioritize since room devices are likely not used at a desk space), contextual data about the workspace (e.g., relative size, whether the room is “private”, etc.), or any other data associated with the workspace. The parameters may include workspace types, such as pre-configured workspace types (e.g., quiet room, desk, open office, conference room, huddle room, etc.). Further, a dynamic workspace type may be prepopulated to reflect a workspace with evolving characteristics. For example, a multi-purpose workspace may be associated with a dynamic workspace type because it may be transformed from a workspace serving one purpose (e.g., a classroom) to a workspace serving another purpose (e.g., a conference room). The parameters may further include workspace definitions such as a meeting room fits 6 to 20 chairs while a desk fits one chair. Another example definition may include the following: “A quiet room is defined as a small room (˜2 m\hat{ }2), 1 chair, and an enclosed space for one person. It typically has desk devices. It is private if there is no window in the office.” The parameters may be updated based on changes made to the workspace definitions.

In certain embodiments, the prompt may include metadata along with workspace definitions. For example, the metadata may include device type (e.g., a desktop likely indicates a quiet room whereas an interactive display and collaboration device indicates a meeting room) and size of the workspace determined based on camera range. Further, metadata such as workspace material type may be included as input. Sound tests (e.g., a RT60 sound test measuring how long it takes a room's reverb time (RT) to decay 60 decibels (dB)) may be performed to provide sound quality checks and generate the workspace size and workspace material type (e.g., glass, wall, enclosed, open, etc.). These metadata may be included as a hint to help narrow the focus of the LLM and to keep the LLM from hallucinating and mapping to irrelevant classifications. Based on the prompt and the image, the workspace classification model 323 may count a number of chairs and compare the count to the qualitative description included in the prompt.

In certain embodiments, the user may enhance or override the classification through custom workspace types. For example, the user may provide a sample image of their workspace type to match a specific design style of their office (e.g., a unique cubicle style, etc.). Based on the inputs, the workspace classification model 323 may provide as output a workspace type, a workspace capacity, and additional metadata about the workspace. The combination of engineered prompt with capacity parameters (e.g., workspace capacity definitions) and detailed instructions ensures reliable and robust workspace type and/or capacity classification. The outputs generated by workspace classification model 323 may be used for capacity planning, fire code capacity checks, occupancy status indicators, finding private rooms, etc. An LLM-based approach provides an improved intelligent workspace classification process compared to the conventional approach of only using object detection for chair counting, which suffers from imprecise camera angles (e.g., chairs hiding out of frame), a mixture of mismatched chair types confusing the count (e.g., beanbags), as well as jackets, equipment, and other things obscuring chairs from view.

In certain embodiments, the initiation of the intelligent workspace classification process may be configured by the administrator. For example, the administrator may initiate the intelligent workspace classification process after office hours to ensure images captured would not include private information or faces of people. This provides privacy protection by ensuring that sensitive information is not sent to the workspace classification model 323. Since the one or more sensors for capturing images are likely already installed in or near the workspace or in the one or more user devices, the administrator may configure the sensors or user devices to only capture an image when certain conditions are met (e.g., no people presence in the workspace) or to generate an alert warning one or more users occupying the workspace that an image of the workspace would be captured at a certain time. These measures further enhance privacy protection by ensuring the images captured do not contain sensitive information. Further, in certain embodiments, each registered device may only send a small number of requests to the workspace classification model 323 along with low-resolution images, thus ensuring the intelligent workspace classification process is cost-effective.

The workspace occupancy determination module 320 provides one or more outputs 330. The one or more outputs 330 may include an occupancy status of the workspace, including an actively occupied status 331, a passively occupied status 332, and an unoccupied status 333. The actively occupied status 331 indicates the workspace may be occupied by one or more entities (e.g., a person). In certain embodiments, the user may actively occupy the workspace for the entire duration of an allowed/scheduled occupancy. A timer (e.g., maximum active occupancy duration timer) may begin when the user is detected in the workspace. If the user remains in the workspace when the time out occurs, a pop-up or other notification may be alerted on one or more user devices to let the user know to leave. The passively occupied status 332 indicates the one or more entities no longer occupy the workspace, but one or more objects brought by the one or more entities into the workspace remain in the workspace. The unoccupied status 333 indicates the workspace is not occupied by one or more entities. The one or more outputs 330 may further include other information, including but not limited to workspace capacity or workspace usage status (e.g., workspace resources are underused).

One or more workspace management actions or one or more network management actions 340 may be performed based on the one or more outputs 330. For example, the one or more workspace management actions or one or more network management actions 340 may include an action 341 to trigger an alert to warn user of passive occupancy, an action 342 to update workspace utilization metrics, an action 343 to update a workspace scheduler system, an action 344 to send a message to a workplace resource management system. In certain embodiments, the one or more workspace management actions or one or more network management actions 340 may be performed in response to workspace camping situations where workspace resources (e.g., furniture, electronic equipment, etc.) are not adequately used. For example, an inadequate number of people have occupied a workspace (e.g., two people come to sit in a meeting room with a capacity for 20). Another example includes when a person is detected as passively or actively occupying a room with specialized equipment but not using it (e.g., not using an electronic whiteboard or a video conferencing device in a conference room).

One or more additional workspace management or network management actions 345 may be performed. For example, one or more network management actions may include initiating an access control action on one or more network devices or one or more user devices in the workspace to prevent the person from accessing the one or more network devices or the one or more user devices in the workspace, changing a user permission of the person to the one or more network devices or the one or more user devices, preventing the one or more network devices or the one or more user devices in the workspace from receiving one or more network packets, altering a network resource allocation scheme for data sent to or from the workspace, initiating an access control action on one or more equipment (e.g., locking a cabinet), securing an entrance to the workspace, or any other action configured to manage the network devices, user devices, and/or equipment in the workspace.

One or more workspace management actions may include sending to the person or to a workspace administrator an alert communication to retrieve the one or more objects, sending to the workspace administrator a communication to reassign the workspace, changing an occupancy state indicator to indicate the workspace is available, or any other action configured to manage the workspace. Further, the one or more workspace management actions may include reassigning one or more users to an unoccupied workspace that is better aligned with their workspace needs (e.g., occupancy duration requirements) or an organization's workspace allocation schemes. In one example, a person with additional workspace needs at the conclusion of a scheduled occupancy may be reassigned to another workspace that has a longer maximum allowed occupancy duration. In another example, two people who are actively or passively occupying a workspace (e.g., conference room) designed to accommodate at least eight people may be reassigned to a smaller workspace (e.g., a “huddle” space). These workspace management actions enable efficient workspace allocation while dynamically meeting user requirements.

In certain embodiments, the one or more workspace management actions or one or more network management actions 340 may be triggered upon determining a period of passive occupancy exceeds a maximum unoccupancy duration. The maximum unoccupancy duration may be described in an occupancy policy associated with a specific workspace type. For example, the workspace classification model 323 may determine the workspace is a meeting room, a desk, a “huddle” space, a “focus” space, or another type of workspace as described above. The occupancy policy associated with the “meeting room” workspace type may identify that the maximum unoccupancy duration is 30 minutes, whereas the occupancy policy associated with the “desk” workspace type may identify that the maximum unoccupancy duration is two hours. The occupancy policy may further include requirements such as maximum capacity, access control, scheduling restrictions, privacy requirements, etc. The occupancy policy may be dynamically updated based on user preference.

By way of example, upon detecting the workspace (e.g., meeting room) has been passively occupied (e.g., as indicated by the passively occupied status 332) for one hour, the one or more workspace management actions or one or more network management actions 340 may be triggered because the period of passive occupancy has exceeded a maximum unoccupancy duration allowed by the occupancy policy associated with the “meeting room” workspace type. This provides enhanced workspace management and/or network management by detecting the issue of passive occupancy in a timely manner and generating solutions that ensure the efficient use of workspace and/or network resources.

FIG. 3B is a diagram illustrating a workspace utilization metrics dashboard, according to an example embodiment. A workspace utilization metrics dashboard 300B, implemented via a graphical user interface, displays workspace utilization metrics determined in various embodiments described herein. For example, the workspace utilization metrics dashboard 300B provides an interactive component 360 configured to display utilization metrics to a user and receive user input for updating the utilization metrics. The interactive component 360 may display information such as device availability (e.g., idle or in use), workspace occupancy state, number of occupants, workspace booking status, and a number of paired applications associated with the workspace. For example, the interactive component 360 may indicate to the user that the workspace is occupied (e.g., using a “Yes/No” indicator). Upon receiving inputs from the user to update the utilization metrics, an updated interactive component 370 is configured to display updated utilization metrics. For example, the user may have provided input to change the workspace occupancy state from “Yes” to “No.” Updates to the utilization metrics may be received from the user or from workspace utilization metric analytics determined in various embodiments described herein.

The workspace utilization metrics dashboard 300B may further include an interactive component 365 configured to display classification status of a plurality of workspaces. For example, the interactive component 365 may indicate that a majority of workspaces (e.g., 99.9%) has not been set, or classified, to a workspace category/type. Upon receiving input from the user and/or based on workspace classification outputs from the workspace classification model in various embodiments described herein, an updated interactive component 375 may indicate that only a small percentage (e.g., 0.07%) of the workspaces remains to be categorized.

FIG. 3C is a diagram illustrating a graphical user interface 300C displaying a workspace management dashboard, according to an example embodiment. The graphical user interface 300C of a user device displays workspace management information obtained in various embodiments described herein. For example, the graphical user interface 300C generates and displays a workspace management dashboard 380. The workspace management dashboard 380 may be displayed on a user device located in or near the workspace. For example, the workspace management dashboard 380 may be displayed as a room panel on a tablet located near the entrance of a meeting room.

The workspace management dashboard 380 includes a text box 381 displaying a workspace identifier (ID), a text box 382 displaying a workspace type, a text box 383 displaying a scheduled occupancy (e.g., the workspace is scheduled to be occupied from 1:00 pm to 2:00 pm), a text box 384 displaying a maximum capacity of the workspace, a text box 385 displaying an occupancy status, and a text box 386 displaying an occupant count. The user may update the information displaying in each of text boxes 381-386 by providing text inputs into the text box.

The workspace management dashboard 380 includes a button 387 displaying the text “Be right back!” The button 387, when clicked or selected, enables the user to indicate an intention to return to the workspace within a short period of time. For example, the user may want to take a short bio break or coffee break. In certain embodiments, when the user clicks the button 387, a grace period timer may be activated. A duration of unoccupancy may not begin until the grace period has passed since the user has provided an indication that they do not intend to passively occupy the workspace.

The workspace management dashboard 380 includes a button 388 displaying the text “End Occupancy.” The button 388, when clicked or selected, enables the user to indicate an intention to end occupancy of the workspace. The workspace management dashboard 380 further includes a button 389 displaying the text “Extend Occupancy.” The button 389, when clicked, enables the user to indicate an intent to extend occupancy of the workspace. For example, the user may want to continue their occupancy of the workspace after a scheduled occupancy has ended. The button 389 enables an occupancy extension request to be sent to an administrator of the workspace management system.

When the user selects the button 387, the button 388, or the button 389, the workspace management information displayed in each of text boxes 381-386 may be updated accordingly. In one scenario, when the user ends their occupancy, via the button 388, prior to the end of a scheduled occupancy, the occupancy status may be updated to “unoccupied” and the scheduled occupancy may be updated to “none.” In another scenario, when the user extends their occupancy via the button 389, the scheduled occupancy may be updated to reflect the extended period of occupancy.

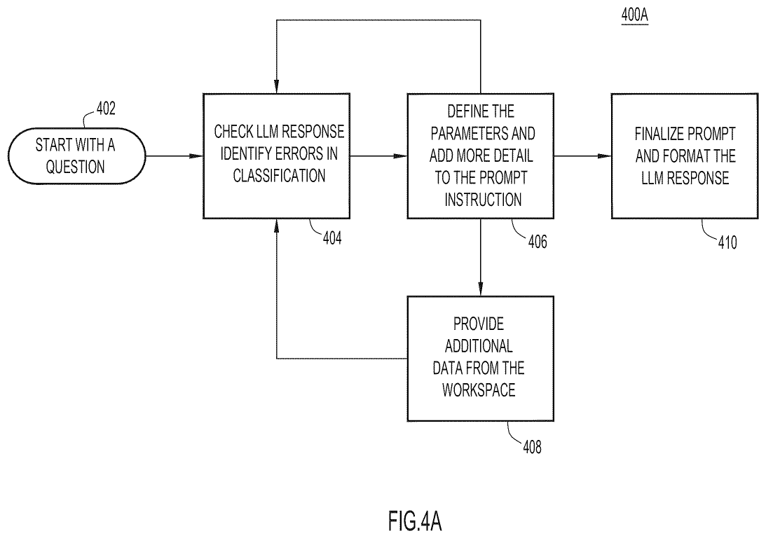

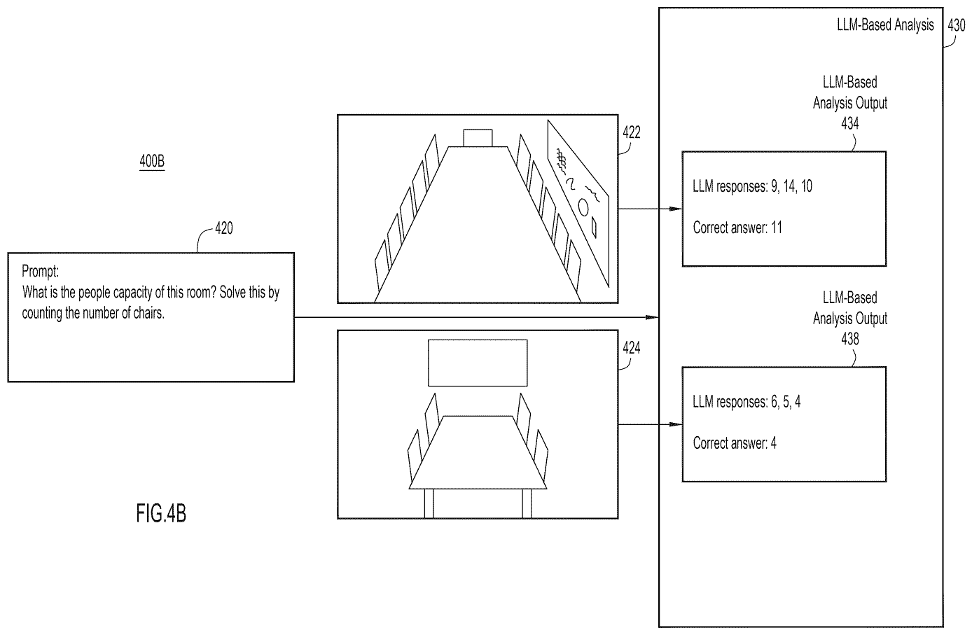

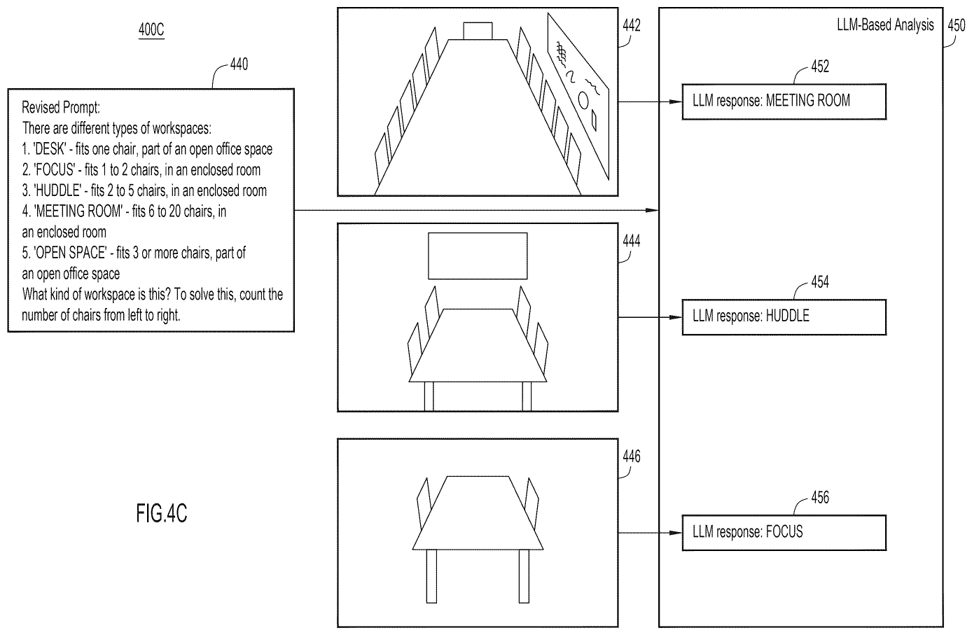

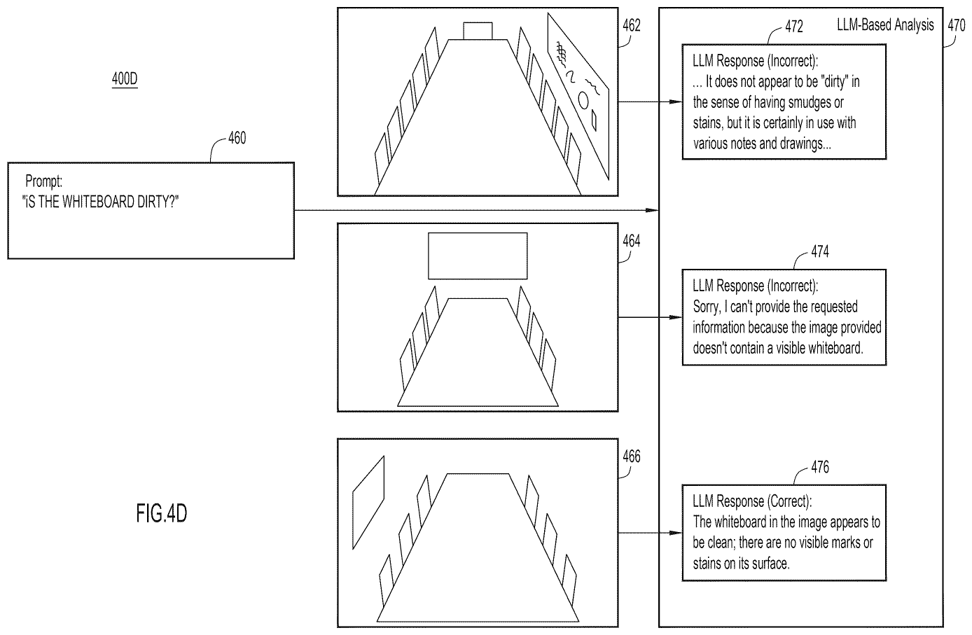

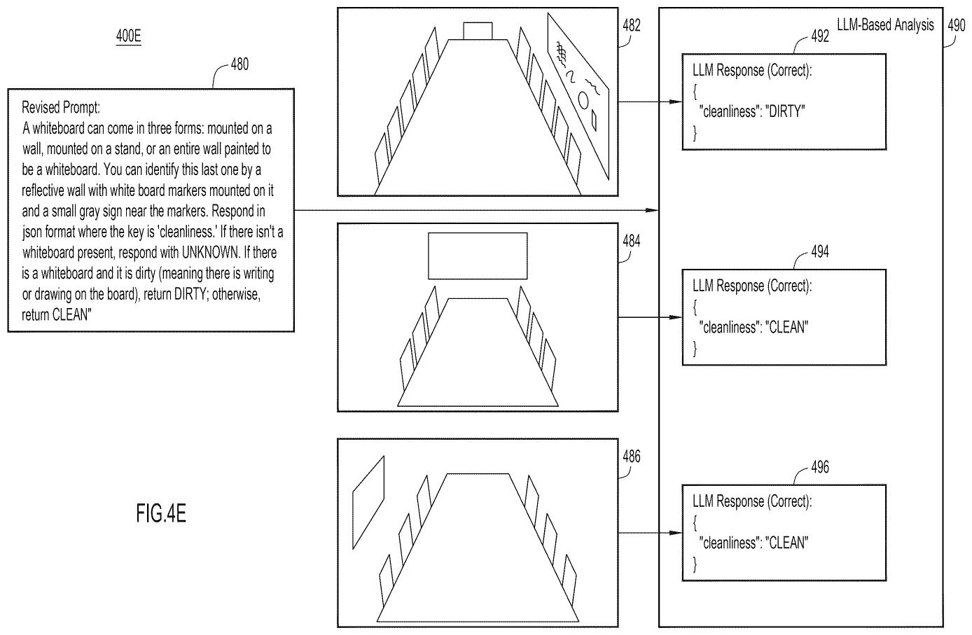

FIG. 4A is a block diagram illustrating a processing flow 400A for classifying a workspace type or workspace state via a large language model (LLM), according to an example embodiment. The processing flow 400A begins with a user providing a question as an input prompt at operation 402. The question may be provided as text or speech that that can be converted to text. In certain embodiments, the user may provide a question and/or a statement as the input prompt. The input prompt (e.g., question) is sent to an LLM, which generates a response (e.g., classification of workspace type or workspace state) to the input prompt at operation 404. That is, for example, the LLM may classify the workspace type (e.g., “huddle” or conference room) and/or workspace state (e.g., “clean” or “dirty”). Further, at operation 404, the response is evaluated to identify one or more errors in the LLM classification outputs. The one or more errors may be determined using any suitable functions (e.g., loss function or cost function) configured to calculate one or more differences between classification outputs/labels and ground truth labels (e.g., actual workspace type/state identified by a human).

Based on the one or more errors in classification, definition of parameters and additional details may be added to the instruction in the input prompt to generate an updated prompt at operation 406. For example, definition of each workspace type (e.g., the “huddle” workspace type fits 2 to 5 chairs in an enclosed room) may be added to the input prompt. In certain embodiments, the definition of parameters may be dynamically updated to reflect evolving workspace characteristics. Based on the updated prompt, additional data (e.g., sample workspace snapshots) may be obtained from the workspace and provided to the LLM at operation 408. The updated prompt determined at operation 406 and/or the additional data obtained at operation 408 may be provided to the LLM in an iterative manner until errors in responses generated by the LLM reach a threshold (e.g., classification error rate of 10% or less). The threshold may be configured based on user preference and/or requirement. Further, at operation 410, the updated prompt is finalized and the LLM response is formatted. The format of the LLM response may be preconfigured (e.g., format follows a specific template) or dynamically determined based on instructions provided in the input prompt.

FIG. 4B is a block diagram illustrating an example processing flow 400B providing an LLM-based analysis output to a prompt, according to an example embodiment. The processing flow 400B includes a prompt 420, an image 422, and an image 424, which are provided as inputs to an LLM-based analysis operation 430. Inputs to the LLM-based analysis operation 430 may include one or more of textual inputs (e.g., statements, questions, etc.), images, sound, video, etc. Based on the prompt 420, the image 422, and the image 424, the LLM-based analysis operation 430 generates an LLM-based analysis output for each of the two images. The LLM-based analysis output may include one or more of textual outputs, images, sound, video, etc.

For example, the prompt 420 includes a question (“What is the people capacity of this room?”) and an instruction (“Solve this by counting the number of chairs.”). The LLM-based analysis operation 430 generates an LLM-based analysis output 434 in response to the prompt 420 and the image 422. The LLM-based analysis output 434 may include one or more responses to the prompt 420 based on the image 422. For example, the LLM-based analysis output 434 includes a plurality of responses for the number of chairs in the room generated by an LLM. The LLM-based analysis output 434 may further include the correct answer (which may be provided by a user or another source). Further, the LLM-based analysis operation 430 generates an LLM-based analysis output 438 in response to the prompt 420 and the image 424. For example, the LLM-based analysis output 438 includes a plurality of responses for the number of chairs in the room generated by an LLM. The LLM-based analysis output 438 may further include the correct answer (which may be provided by a user or another source). As indicated by the LLM-based analysis output 434 and the LLM-based analysis output 438, it may take the LLM multiple attempts to reach the correct answer. The prompt 420 may be refined to provide enhanced instructions that would yield more accurate results.

With continued reference to FIG. 4B, FIG. 4C is a diagram illustrating an example processing flow 400C for providing an LLM-based analysis output to a revised prompt, according to an example embodiment. The processing flow 400C includes a revised prompt 440, an image 442, an image 444, and an image 446, which are provided as inputs to an LLM-based analysis operation 450. The revised prompt 440 includes detailed background information (e.g., different workspace types and corresponding capacity) in addition to the question and instruction in the prompt 420 of FIG. 4B. Based on the revised prompt 440, the image 442, the image 444, and the image 446, the LLM-based analysis operation 450 generates an LLM-based analysis output for each of the three images. The LLM-based analysis output may include one or more of textual outputs, images, sound, video, etc.

For example, the LLM-based analysis operation 450 generates an LLM-based analysis output 452 in response to the revised prompt 440 and the image 442. The LLM-based analysis output 452 may include one or more responses to the revised prompt 440 based on the image 442. The LLM-based analysis operation 450 generates an LLM-based analysis output 454 in response to the revised prompt 440 and the image 444. The LLM-based analysis output 454 may include one or more responses to the revised prompt 440 based on the image 444. The LLM-based analysis operation 450 generates an LLM-based analysis output 456 in response to the revised prompt 440 and the image 446. The LLM-based analysis output 456 may include one or more responses to the revised prompt 440 based on the image 446. Based on the details provided in the revised prompt 440, each of the LLM-based analysis outputs 452, 454, and 456 provides a correct response identifying the corresponding workspace type for the workspace displayed in the image.

FIG. 4D is a block diagram illustrating an example processing flow 400D for providing an LLM-based analysis output to a prompt, according to an example embodiment. The processing flow 400D includes a prompt 460, an image 462, an image 464, and an image 466, which are provided as inputs to an LLM-based analysis operation 470. Inputs to the LLM-based analysis operation 470 may include one or more of textual inputs (e.g., statements, questions, etc.), images, sound, video, etc. Based on the prompt 460, the image 462, the image 464, and the image 466, the LLM-based analysis operation 470 generates an LLM-based analysis output for each of the three images. The LLM-based analysis output may include one or more of textual outputs, images, sound, video, etc.

For example, the LLM-based analysis operation 470 generates an LLM-based analysis output 472 in response to the prompt 460 and the image 462. The LLM-based analysis output 472 may include one or more responses to the prompt 460 based on the image 462. The LLM-based analysis operation 470 generates an LLM-based analysis output 474 in response to the prompt 460 and the image 464. The LLM-based analysis output 474 may include one or more responses to the prompt 460 based on the image 464. The LLM-based analysis operation 470 generates an LLM-based analysis output 476 in response to the prompt 460 and the image 466. The LLM-based analysis output 476 may include one or more responses to the prompt 460 based on the image 466. The LLM-based analysis output 472 and the LLM-based analysis output 474 provide incorrect responses to the prompt 460 (“Is the whiteboard dirty”), whereas the LLM-based analysis output 476 provides a correct response.

With continued reference to FIG. 4D, FIG. 4E is a block diagram illustrating an example processing flow 400E for providing an LLM-based analysis output to a revised prompt, according to an example embodiment. The processing flow 400E includes a revised prompt 480, an image 482, an image 484, and an image 486, which are provided as inputs to an LLM-based analysis operation 490. The revised prompt 480 includes detailed background information (e.g., possible locations of the whiteboard, format of response, classification objective, etc.) when compared to the prompt 460 of FIG. 4D. Based on the revised prompt 480, the image 482, the image 484, and the image 486, the LLM-based analysis operation 490 generates an LLM-based analysis output for each of the three images. The LLM-based analysis output may include one or more of textual outputs, images, sound, video, etc.

For example, the LLM-based analysis operation 490 generates an LLM-based analysis output 492 in response to the revised prompt 480 and the image 482. The LLM-based analysis output 492 may include one or more responses to the revised prompt 480 based on the image 482. The LLM-based analysis operation 490 generates an LLM-based analysis output 494 in response to the revised prompt 480 and the image 484. The LLM-based analysis output 494 may include one or more responses to the revised prompt 480 based on the image 484. The LLM-based analysis operation 490 generates an LLM-based analysis output 496 in response to the revised prompt 480 and the image 486. The LLM-based analysis output 496 may include one or more responses to the revised prompt 480 based on the image 486. Based on the details provided in the revised prompt 480, each of the LLM-based analysis output 492, 494, and 496 provides a correct response identifying the cleanliness of the workspace displayed in the image.

Each of the LLM-based analysis operations 430, 450, 470, and 490 described in FIGS. 4B-4E may include one or more LLMs. The one or more LLMs described herein may include transformer-based models such as Bidirectional encoder representations from transformers (BERT), Robustly Optimized BERT Approach (RoBERTa), generative pre-trained transformer (GPT), etc. The software instructions and associated data for the one or more LLMs may be stored locally on a user device or accessed via a proxy (e.g., cloud service).

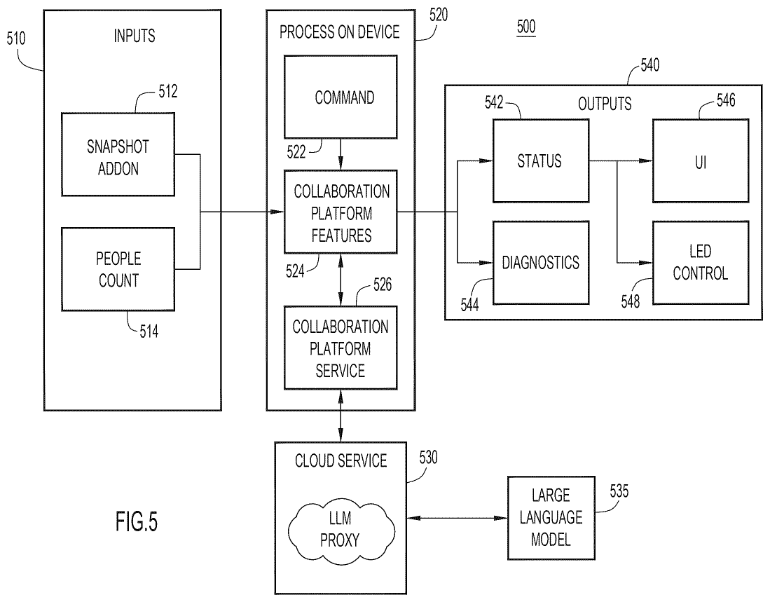

FIG. 5 is a block diagram illustrating a processing flow 500 for generating outputs describing a workspace via an LLM, according to an example embodiment. The processing flow 500 involves obtaining a plurality of inputs 510, which includes a snapshot addon 512 providing one or more snapshots of a workspace and a people count 514. The snapshot addon 512 and the people count 514 are provided to a processing operation 520 on a device. The processing operation 520 includes providing a command 522, the snapshot addon 512, and the people count 514 to form a plurality of collaboration platform features 524. The plurality of collaboration platform features 524 are provided to a collaboration platform service 526. The collaboration platform service 526, via a cloud service 530 serving as a LLM proxy, communicates with a large language model 535. In certain embodiments, the collaboration platform service 526 communicates a prompt including information from the plurality of inputs 510 to the large language model 535 via the cloud service 530. The large language model 535 returns a response to the collaboration platform service 526 via the cloud service 530. The collaboration platform service 526 returns the response to the plurality of collaboration platform features 524, which is configured to provide a plurality of outputs 540. The plurality of outputs 540 include a status 542 (e.g., workspace occupancy status), one or more diagnostics 544 (e.g., cleanliness of a workspace), data displayed on a user interface 546, and a light-emitting diode (LED) control 548. Based on the status 542, the user interface 546 (e.g., workspace utilization metrics dashboard) and the LED control 548 may be updated.

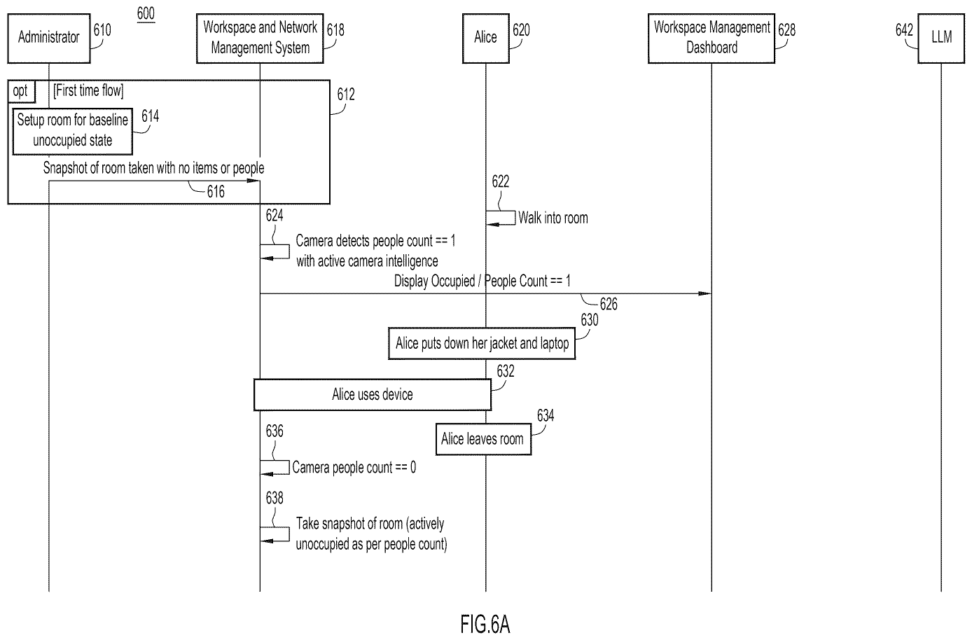

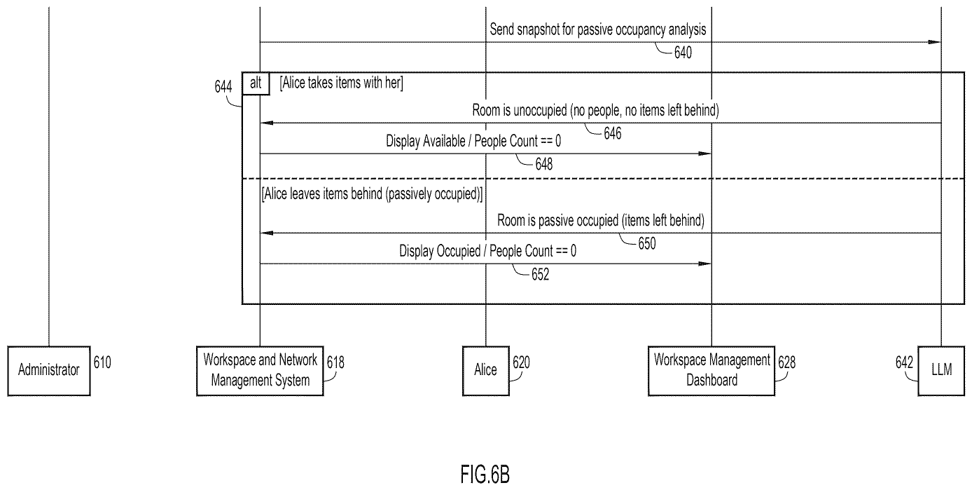

FIG. 6A is an operational sequence diagram 600 for detecting passive occupancy of a workspace, according to an example embodiment. In the operational sequence diagram 600, an administrator 610, at 612, setups the workspace (e.g., room) for a baseline unoccupied state at operation 614. For example, the administrator 610 determines the workspace is unoccupied and sets one or more maximum duration timers for which a user may utilize a workspace (e.g., setting a maximum booking time). The one or more maximum duration timers may include a maximum passive occupancy duration timer and a maximum active occupancy duration timer. While the workspace remains unoccupied (e.g., without presence of a person or one or more objects brought by the person), a snapshot of the workspace is captured at operation 616 and transmitted to a workspace and network management system 618. After a user (“Alice”) 620 walks into the workspace at operation 622, they may be required to sign in through hot desking, book the workspace through an ad hoc booking system, or simply begin to use a user device (e.g., making a call). The occupancy of the workspace is updated based on booking information and/or through the workspace going into use.

A snapshot of the workspace may be captured when the user (“Alice”) 620 has entered the workspace. Using active camera intelligence, a camera may detect a person has occupied the workspace at operation 624. The occupancy status of the workspace is updated to “occupied” and people count is updated to “1” at operation 626. The occupancy status and/or people count may be displayed on a workspace management dashboard 628. For example, the workspace management dashboard 628 may be displayed as a room panel on a tablet located near the entrance of a meeting room. The snapshot showing the workspace as unoccupied may be compared to the snapshot showing the workspace as occupied by the user to determine how the workspace has changed and if the user has brought items into the workspace. In certain embodiments, the comparison of various snapshots of the workspace may be performed via a comparison analysis of one or more frames extracted from a video footage/stream of the workspace.

After the user (“Alice”) 620 begins to occupy the workspace, they may place one or more objects (e.g., jacket, laptop, etc.) in the workspace at operation 630. The user (“Alice”) 620 may use one or more user devices at operation 632. After some time has passed, the user (“Alice”) 620 may leave the workspace at operation 634. Occupancy status of the workspace may be determined by checking a people count (e.g., camera people count==0) at operation 636. Additional data that may be used include an absence of device pairing and/or an absence of device usage, etc. For example, after the user (“Alice”) 620 leaves the workspace, the occupancy status may be updated to “unoccupied.” At operation 638, upon determining the workspace is unoccupied, a snapshot of the unoccupied workspace may be captured.

With continued reference to FIG. 6A, FIG. 6B continues to illustrate the operational sequence diagram 600 for detecting passive occupancy of a workspace, according to an example embodiment. At operation 640, the snapshots are sent to an LLM 642 for passive occupancy analysis. The passive occupancy analysis performed by the LLM 642 at 644 may include comparing an original snapshot of the workspace (e.g., when the workspace is not occupied by the user and/or one or more objects brought by the user) to a new snapshot of the workspace (e.g., after the user ends their occupancy) and performing person detection and/or object detection on the snapshots to determine one or more deviations between the original snapshot and the new snapshot. In one scenario, based on the one or more deviations, the LLM 642 may determine and transmit information indicating the workspace is unoccupied (e.g., no person or objects brought by the person are left behind). The LLM 642 provides the workspace and network management system 618 an indication that the workspace is unoccupied at operation 646. The workspace may be displayed as available and people count is updated to “0” on the workspace management dashboard 628 at operation 648.

In another scenario, based on the one or more deviations, the LLM 642 may detect one or more objects the user (“Alice”) 620 may have left in the workspace, such as a backpack, laptop, jacket, coffee cup, etc. These objects indicate the user is passively occupying the workspace and “camping” at the workspace. The LLM 642 provides the workspace and network management system 618 an indication that the workspace is passively occupied at operation 650. The workspace may be displayed as occupied (e.g., passively occupied) and people count is updated to “0” on the workspace management dashboard 628 at operation 652. It should be understood that while “room” is used as an exemplary workspace in FIGS. 6A and 6B, the operations of FIGS. 6A and 6B are applicable to any suitable workspace, including but not limited to rooms, desks, etc.

Based on the indication of passive occupancy, the maximum passive occupancy duration timer is activated. In certain embodiments, the maximum passive occupancy duration timer may be on a shorter duration than the maximum active occupancy duration timer. When a maximum booking timer or the maximum passive occupancy duration timer fires, an indication may be transmitted to the user through a message (via email, short message service (SMS), collaboration application, etc.) that the workspace will be freed and that they should collect their items. Alternatively or additionally, workplace management personnel may be alerted to come and clean up the workspace and/or move the user's items.

In certain embodiments, if no objects belonging to the user are left in the workspace, passive occupancy may be detected by determining if the user is physically present at another workspace based on proximity usage of other devices (e.g., devices located in the same building). For example, if the user is booking, signed in, or otherwise maintaining an active session in the workspace, but is in another meeting as detected through face recognition algorithm, proximity pairing, Wi-Fi WLAN proximity, in the roster list of another call, or otherwise detected as being in another area (e.g., attending another meeting), the user may be considered passively occupying the workspace. Further, if the user books a different workspace, overlapping a time the user has booked the passively occupied (“camped”) workspace, then passive occupancy may be flagged. A grace period timer may be activated to accommodate short breaks (e.g., bio breaks, coffee breaks, etc.) prior to triggering one or more workspace management or network management actions.

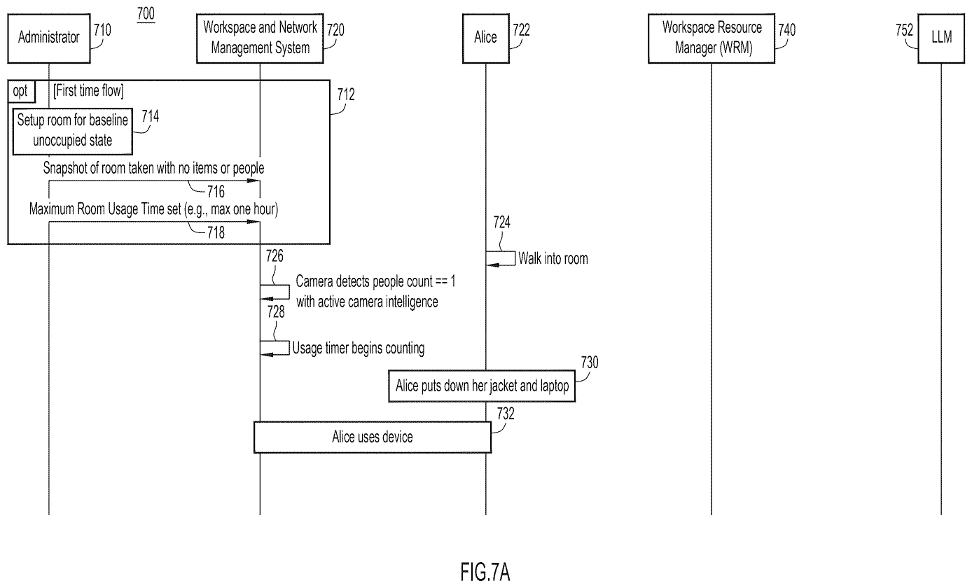

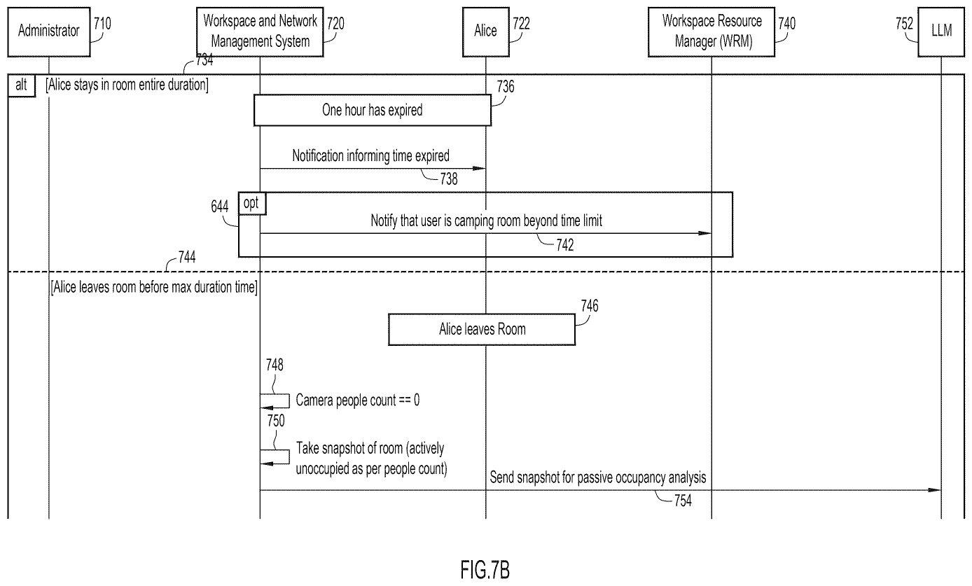

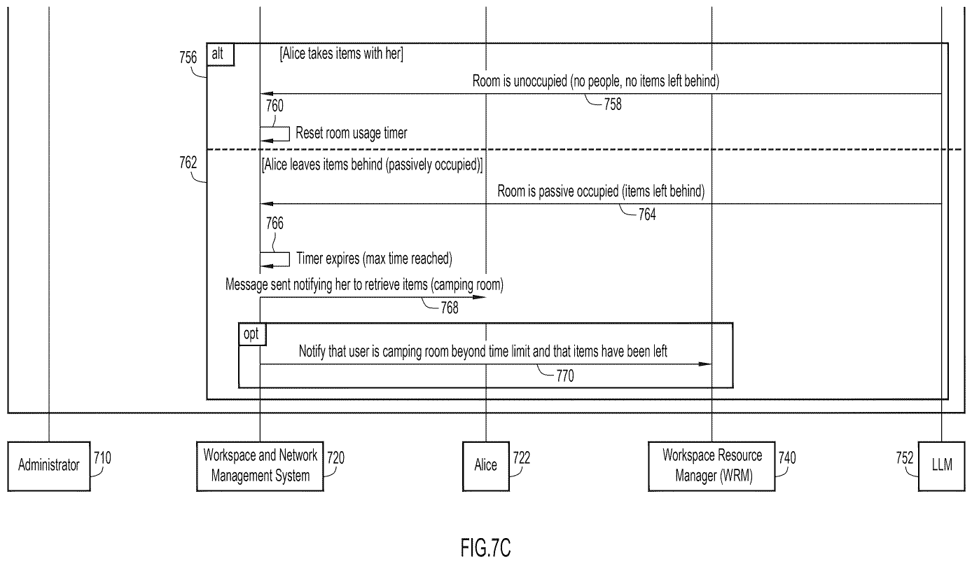

FIG. 7A is an operational sequence diagram 700 for providing a notification in response to detected passive occupancy of a workspace, according to an example embodiment. In the operational sequence diagram 700, an administrator 710, at 712, sets up the workspace (e.g., room) for a baseline unoccupied state at operation 714. While the workspace remains unoccupied (e.g., without presence of a person or one or more objects brought by the person), a snapshot is captured of the workspace at operation 716 and a maximum workspace usage time is set (e.g., maximum room usage time is set to one hour) at operation 718. The snapshot and the maximum workspace usage time are transmitted to a workspace and network management system 720. Once a user (“Alice”) 722 walks into the workspace at operation 724, they may be required to sign in through hot desking, book the workspace through an ad hoc booking system, or simply begin to use a user device (e.g., making a call). The occupancy of the workspace is updated based on booking information and/or through the workspace going into use.

A snapshot of the workspace may be captured when the user (“Alice”) 722 has entered the workspace. Using active camera intelligence, a camera may detect a person has occupied the workspace and the people count is updated to “1” at operation 726. A workspace usage timer begins counting at operation 728. After the user (“Alice”) 722 begins to occupy the workspace, they may place one or more objects (e.g., jacket, laptop, etc.) in the workspace at operation 730. The user (“Alice”) 722 may use one or more user devices at operation 732.

With continued reference to FIG. 7A, FIG. 7B continues to illustrate the operational sequence diagram 700 for providing a notification in response to detected passive occupancy of a workspace, according to an example embodiment. At 734, the user (“Alice”) 722 may remain in the workspace for the entire duration allowed by the maximum workspace usage time. For example, when one hour (maximum workspace usage time) has expired at operation 736, a notification is sent to Alice 722 indicating the time has expired at 738, and a notification indicating maximum workspace usage time has expired is provided to a workspace resource manager (WRM) 740 at operation 742.

At 744, the user (“Alice”) 722 may leave the workspace prior to an expiration of the maximum workspace usage time (also known as “max duration time”). For example, the user (“Alice”) 722 leaves the workspace at operation 746. The camera people count is updated to “0” at operation 748. A snapshot of the workspace, which is now considered actively unoccupied per the people count, may be captured at operation 750. The snapshot is sent to a LLM 752 for passive occupancy analysis at operation 754.

With continued reference to FIGS. 7A and 7B, FIG. 7C continues to illustrate the operational sequence diagram 700 for providing a notification in response to detected passive occupancy of a workspace, according to an example embodiment. At 756, which pertains to a scenario in which the user (“Alice”) 722 takes their personal items with them when they leave the workspace, the LLM 752 provides an indication that the workspace is unoccupied by the user and the user has not left any personal items at operation 758. The workspace usage timer is reset at operation 760 based on the unoccupancy indication.

At 762, which pertains to another scenario in which the user (“Alice”) 722 leaves personal items behind and thus passively occupies the workspace, the LLM 752 provides an indication that the workspace is passively occupied at operation 764. After the maximum workspace usage time is reached (e.g., a maximum workspace usage timer expires) at operation 766, a message is sent to the user (“Alice”) 722 to notify them to retrieve their personal items at operation 768. A notification is sent to the workspace resource manager 740 indicating that the user (“Alice”) 722 has passively occupied (or “camped”) at the workspace beyond an allowed time limit and that their personal items remain in the workspace at operation 770.

In certain embodiments, upon detecting personal items have been left in a workspace last used by multiple users, a meeting roster list may be evaluated, and a message may be automatically sent to all meeting attendees. The message may include information on how to retrieve the personal items from the workplace resource manager 740. Computer vision models, face recognition models, and/or object detection models may be utilized to determine if an item may be associated with a specific user. The most likely owner may be contacted directly to retrieve the items. It should be understood that while “room” is used as an exemplary workspace in FIGS. 7A-7C, operations of FIGS. 7A-7C are applicable to any suitable workspace, including but not limited to rooms, desks, etc.

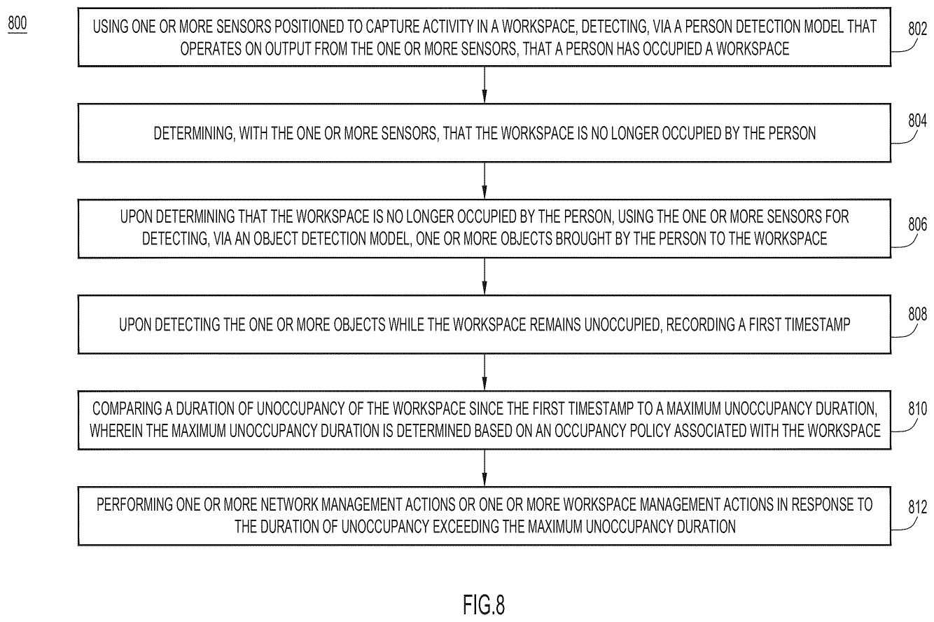

FIG. 8 is a flow diagram illustrating a method 800 for performing one or more network management actions or one or more workspace management actions, according to an example embodiment. The method 800 may be implemented by the user devices 117a-n of FIG. 1.

At 802, the method 800 involves using one or more sensors positioned to capture activity in a workspace, detecting, via a person detection model that operates on output from the one or more sensors, that a person has occupied a workspace.

At 804, the method 800 involves determining, with the one or more sensors, that the workspace is no longer occupied by the person.

At 806, the method 800 involves upon determining that the workspace is no longer occupied by the person, using the one or more sensors for detecting, via an object detection model, one or more objects brought by the person to the workspace.

At 808, the method 800 involves upon detecting the one or more objects while the workspace remains unoccupied, recording a first timestamp.

At 810, the method 800 involves comparing a duration of unoccupancy of the workspace since the first timestamp to a maximum unoccupancy duration. In one example, the maximum unoccupancy duration is determined based on an occupancy policy associated with the workspace.

At 812, the method 800 involves performing one or more network management actions or one or more workspace management actions in response to the duration of unoccupancy exceeding the maximum unoccupancy duration.

In the method 800, the one or more network management actions include one or more of initiating an access control action on one or more network devices or one or more user devices in the workspace to prevent the person from accessing the one or more network devices or the one or more user devices in the workspace, changing a user permission of the person to the one or more network devices or the one or more user devices, preventing the one or more network devices or the one or more user devices in the workspace from receiving one or more network packets, or altering a network resource allocation scheme for data sent to or from the workspace.

In the method 800, the one or more workspace management actions include one or more of sending to the person or to a workspace administrator an alert communication to retrieve the one or more objects, sending to the workspace administrator a communication to reassign the workspace, or changing an occupancy state indicator to indicate the workspace is available.

In the method 800, detecting, via the person detection model, that the person has occupied the workspace involves capturing with at least one video camera a first image of the workspace when the workspace is unoccupied, and generating, via the person detection model, one or more classifications based on the first image, wherein the one or more classifications include the person.

In the method 800, determining that the workspace is no longer occupied by the person involves capturing with the at least one video camera a second image of the workspace, comparing the first image and the second image to determine one or more deviations, and determining that the workspace is no longer occupied by the person based on the one or more deviations.

In the method 800, detecting, via the object detection model, the one or more objects brought by the person to the workspace involves capturing with the at least one video camera a second image of the workspace upon determining that the workspace is no longer occupied by the person, comparing the first image and the second image to determine one or more deviations, and detecting, via the object detection model, the one or more objects brought by the person based on the one or more deviations.

In the method 800, determining that the workspace is no longer occupied by the person involves determining that the person has occupied another workspace based on one or more of: an occupancy state indicator, a device pairing status, device usage information, one or more outputs generated by the person detection model or a face recognition algorithm, or proximity pairing information.

In the method 800, the maximum unoccupancy duration may be determined based on an occupancy policy associated with the workspace, and the occupancy policy is based on a workspace type of the workspace determined via a workspace classification model configured to classify the workspace based on one or more of: object detection, room layout analysis, or device usage information, and wherein the workspace classification model includes a large language model, a computer vision model, or a combination thereof.

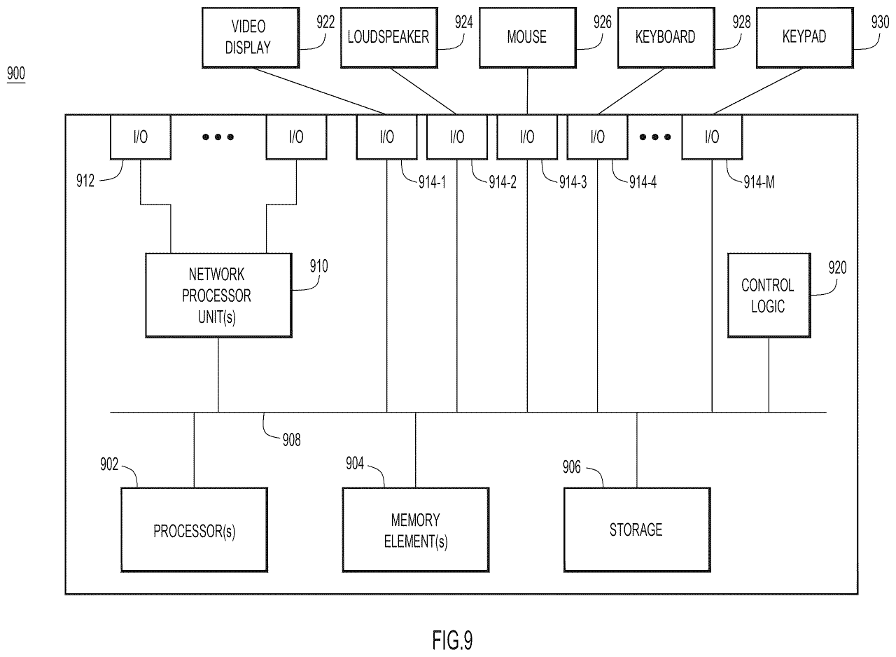

Referring to FIG. 9, FIG. 9 illustrates a hardware block diagram of a computing device 900 that may perform functions associated with operations discussed herein in connection with the techniques depicted in FIGS. 1, 2A-2D, 3A-3C, 4A-4E, 5, 6A, 6B, 7A-7C and 8. In various embodiments, a computing device or apparatus, such as computing device 900 or any combination of computing devices 900, may be configured as any entity/entities as discussed for the techniques depicted in connection with FIGS. 1, 2A-2D, 3A-3C, 4A-4E, 5, 6A, 6B, 7A-7C and 8 in order to perform operations of the various techniques discussed herein.

In at least one embodiment, the computing device 900 may be any apparatus that may include one or more processor(s) 902, one or more memory element(s) 904, storage 906, a bus 908, one or more network processor unit(s) 910 interconnected with one or more network input/output (I/O) interface(s) 912, one or more I/O interface(s) 914-1, 914-2, 914-3, 914-4, . . . , 914-M, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914-1 to 914-M allow for input and output of data and/or information with other entities that may be connected to computing device 900. For example, I/O interface(s) 914-1 to 914-M may provide a connection to external devices such as a video display (e.g., touch-screen display) 922, loudspeaker 924, mouse 926, keyboard 928, keypad 930, and/or any other suitable input and/or output device now known or hereafter developed. It is also envisioned that many of these external devices may be integrated as part of the computing device 900. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a computer-implemented method including: using one or more sensors positioned to capture activity in a workspace, detecting, via a person detection model that operates on output from the one or more sensors, that a person has occupied a workspace; determining, with the one or more sensors, that the workspace is no longer occupied by the person; upon determining that the workspace is no longer occupied by the person, using the one or more sensors for detecting, via an object detection model, one or more objects brought by the person to the workspace; upon detecting the one or more objects while the workspace remains unoccupied, recording a first timestamp; comparing a duration of unoccupancy of the workspace since the first timestamp to a maximum unoccupancy duration; and performing one or more network management actions or one or more workspace management actions in response to the duration of unoccupancy exceeding the maximum unoccupancy duration.

In some aspects, the techniques described herein relate to a computer-implemented method, wherein the one or more network management actions include one or more of: initiating an access control action on one or more network devices or one or more user devices in the workspace to prevent the person from accessing the one or more network devices or the one or more user devices in the workspace, changing a user permission of the person to the one or more network devices or the one or more user devices, preventing the one or more network devices or the one or more user devices in the workspace from receiving one or more network packets, or altering a network resource allocation scheme for data sent to or from the workspace.

In some aspects, the techniques described herein relate to a computer-implemented method, wherein the one or more workspace management actions include one or more of: sending to the person or to a workspace administrator an alert communication to retrieve the one or more objects, sending to the workspace administrator a communication to reassign the workspace, or changing an occupancy state indicator to indicate the workspace is available.

In some aspects, the techniques described herein relate to a computer-implemented method, wherein detecting, via the person detection model, that the person has occupied the workspace includes: capturing with at least one video camera a first image of the workspace when the workspace is unoccupied; and generating, via the person detection model, one or more classifications based on the first image, wherein the one or more classifications include the person.

In some aspects, the techniques described herein relate to a computer-implemented method, wherein determining that the workspace is no longer occupied by the person includes: capturing with the at least one video camera a second image of the workspace; comparing the first image and the second image to determine one or more deviations; and determining that the workspace is no longer occupied by the person based on the one or more deviations.

In some aspects, the techniques described herein relate to a computer-implemented method, wherein detecting, via the object detection model, the one or more objects brought by the person to the workspace includes: capturing with the at least one video camera a second image of the workspace upon determining that the workspace is no longer occupied by the person; comparing the first image and the second image to determine one or more deviations; and detecting, via the object detection model, the one or more objects brought by the person based on the one or more deviations.

In some aspects, the techniques described herein relate to a computer-implemented method, wherein determining that the workspace is no longer occupied by the person includes: determining that the person has occupied another workspace based on one or more of: an occupancy state indicator, a device pairing status, device usage information, one or more outputs generated by the person detection model or a face recognition algorithm, or proximity pairing information.

In some aspects, the techniques described herein relate to a computer-implemented method, wherein the maximum unoccupancy duration is determined based on an occupancy policy associated with the workspace, and wherein the occupancy policy is based on a workspace type of the workspace determined via a workspace classification model configured to classify the workspace based on one or more of: object detection, room layout analysis, or device usage information, and wherein the workspace classification model includes a large language model, a computer vision model, or a combination thereof.

In some aspects, the techniques described herein relate to an apparatus including: a network interface that enables network communication; a memory; and one or more processors coupled to the network interface and the memory, wherein the one or more processors are configured to perform operations including: using one or more sensors positioned to capture activity in a workspace, detecting, via a person detection model that operates on output from the one or more sensors, that a person has occupied a workspace; determining, with the one or more sensors, that the workspace is no longer occupied by the person; upon determining that the workspace is no longer occupied by the person, using the one or more sensors for detecting, via an object detection model, one or more objects brought by the person to the workspace; upon detecting the one or more objects while the workspace remains unoccupied, recording a first timestamp; comparing a duration of unoccupancy of the workspace since the first timestamp to a maximum unoccupancy duration; and performing one or more network management actions or one or more workspace management actions in response to the duration of unoccupancy exceeding the maximum unoccupancy duration.

In some aspects, the techniques described herein relate to an apparatus, wherein the one or more network management actions include one or more of: initiating an access control action on one or more network devices or one or more user devices in the workspace to prevent the person from accessing the one or more network devices or the one or more user devices in the workspace, changing a user permission of the person to the one or more network devices or the one or more user devices, preventing the one or more network devices or the one or more user devices in the workspace from receiving one or more network packets, or altering a network resource allocation scheme for data sent to or from the workspace.

In some aspects, the techniques described herein relate to an apparatus, wherein the one or more workspace management actions include one or more of: sending to the person or to a workspace administrator an alert communication to retrieve the one or more objects, sending to the workspace administrator a communication to reassign the workspace, or changing an occupancy state indicator to indicate the workspace is available.

In some aspects, the techniques described herein relate to an apparatus, wherein detecting, via the person detection model, that the person has occupied the workspace includes: capturing with at least one video camera a first image of the workspace when the workspace is unoccupied; and generating, via the person detection model, one or more classifications based on the first image, wherein the one or more classifications include the person.

In some aspects, the techniques described herein relate to an apparatus, wherein determining that the workspace is no longer occupied by the person includes: capturing with the at least one video camera a second image of the workspace; comparing the first image and the second image to determine one or more deviations; and determining that the workspace is no longer occupied by the person based on the one or more deviations.

In some aspects, the techniques described herein relate to an apparatus, wherein detecting, via the object detection model, the one or more objects brought by the person to the workspace includes: capturing with the at least one video camera a second image of the workspace upon determining that the workspace is no longer occupied by the person; comparing the first image and the second image to determine one or more deviations; and detecting, via the object detection model, the one or more objects brought by the person based on the one or more deviations.

In some aspects, the techniques described herein relate to an apparatus, wherein determining that the workspace is no longer occupied by the person includes: determining that the person has occupied another workspace based on one or more of: an occupancy state indicator, a device pairing status, device usage information, one or more outputs generated by the person detection model or a face recognition algorithm, or proximity pairing information.

In some aspects, the techniques described herein relate to an apparatus, wherein the maximum unoccupancy duration is determined based on an occupancy policy associated with the workspace, and wherein the occupancy policy is based on a workspace type of the workspace determined via a workspace classification model configured to classify the workspace based on one or more of: object detection, room layout analysis, or device usage information, and wherein the workspace classification model includes a large language model, a computer vision model, or a combination thereof.

In some aspects, the techniques described herein relate to one or more non-transitory computer readable storage media encoded with instructions that, when executed by a processor, cause the processor to: using one or more sensors positioned to capture activity in a workspace, detect, via a person detection model that operates on output from the one or more sensors, that a person has occupied a workspace; determine, with the one or more sensors, that the workspace is no longer occupied by the person; upon determining that the workspace is no longer occupied by the person, use the one or more sensors for detecting, via an object detection model, one or more objects brought by the person to the workspace; upon detecting the one or more objects while the workspace remains unoccupied, record a first timestamp; compare a duration of unoccupancy of the workspace since the first timestamp to a maximum unoccupancy duration; and perform one or more network management actions or one or more workspace management actions in response to the duration of unoccupancy exceeding the maximum unoccupancy duration.

In some aspects, the techniques described herein relate to one or more non-transitory computer readable storage media, wherein the one or more network management actions include one or more of: initiating an access control action on one or more network devices or one or more user devices in the workspace to prevent the person from accessing the one or more network devices or the one or more user devices in the workspace, changing a user permission of the person to the one or more network devices or the one or more user devices, preventing the one or more network devices or the one or more user devices in the workspace from receiving one or more network packets, or altering a network resource allocation scheme for data sent to or from the workspace.

In some aspects, the techniques described herein relate to one or more non-transitory computer readable storage media, wherein the one or more workspace management actions include one or more of: sending to the person or to a workspace administrator an alert communication to retrieve the one or more objects, sending to the workspace administrator a communication to reassign the workspace, or changing an occupancy state indicator to indicate the workspace is available.

In some aspects, the techniques described herein relate to one or more non-transitory computer readable storage media, wherein the maximum unoccupancy duration is determined based on an occupancy policy associated with the workspace, and wherein the occupancy policy is based on a workspace type of the workspace determined via a workspace classification model configured to classify the workspace based on one or more of: object detection, room layout analysis, or device usage information, and wherein the workspace classification model includes a large language model, a computer vision model, or a combination thereof.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A computer-implemented method comprising:
using one or more sensors positioned to capture activity in a workspace, detecting, via a person detection model that operates on output from the one or more sensors, that a person has occupied a workspace;
determining, with the one or more sensors, that the workspace is no longer occupied by the person;
upon determining that the workspace is no longer occupied by the person, using the one or more sensors for detecting, via an object detection model, one or more objects brought by the person to the workspace;
upon detecting the one or more objects while the workspace remains unoccupied, recording a first timestamp;
comparing a duration of unoccupancy of the workspace since the first timestamp to a maximum unoccupancy duration; and
performing one or more network management actions or one or more workspace management actions in response to the duration of unoccupancy exceeding the maximum unoccupancy duration.

2. The computer-implemented method of claim 1, wherein the one or more network management actions include one or more of: initiating an access control action on one or more network devices or one or more user devices in the workspace to prevent the person from accessing the one or more network devices or the one or more user devices in the workspace, changing a user permission of the person to the one or more network devices or the one or more user devices, preventing the one or more network devices or the one or more user devices in the workspace from receiving one or more network packets, or altering a network resource allocation scheme for data sent to or from the workspace.

3. The computer-implemented method of claim 1, wherein the one or more workspace management actions include one or more of: sending to the person or to a workspace administrator an alert communication to retrieve the one or more objects, sending to the workspace administrator a communication to reassign the workspace, or changing an occupancy state indicator to indicate the workspace is available.

4. The computer-implemented method of claim 1, wherein detecting, via the person detection model, that the person has occupied the workspace comprises:
capturing with at least one video camera a first image of the workspace when the workspace is unoccupied; and
generating, via the person detection model, one or more classifications based on the first image, wherein the one or more classifications include the person.

5. The computer-implemented method of claim 4, wherein determining that the workspace is no longer occupied by the person comprises:
capturing with the at least one video camera a second image of the workspace;
comparing the first image and the second image to determine one or more deviations; and
determining that the workspace is no longer occupied by the person based on the one or more deviations.

6. The computer-implemented method of claim 4, wherein detecting, via the object detection model, the one or more objects brought by the person to the workspace comprises:
capturing with the at least one video camera a second image of the workspace upon determining that the workspace is no longer occupied by the person;
comparing the first image and the second image to determine one or more deviations; and
detecting, via the object detection model, the one or more objects brought by the person based on the one or more deviations.

7. The computer-implemented method of claim 1, wherein determining that the workspace is no longer occupied by the person comprises:
determining that the person has occupied another workspace based on one or more of: an occupancy state indicator, a device pairing status, device usage information, one or more outputs generated by the person detection model or a face recognition algorithm, or proximity pairing information.

8. The computer-implemented method of claim 1, wherein the maximum unoccupancy duration is determined based on an occupancy policy associated with the workspace, and wherein the occupancy policy is based on a workspace type of the workspace determined via a workspace classification model configured to classify the workspace based on one or more of: object detection, room layout analysis, or device usage information, and wherein the workspace classification model includes a large language model, a computer vision model, or a combination thereof.

9. An apparatus comprising:
a network interface that enables network communication;
a memory; and
one or more processors coupled to the network interface and the memory, wherein the one or more processors are configured to perform operations including:
using one or more sensors positioned to capture activity in a workspace, detecting, via a person detection model that operates on output from the one or more sensors, that a person has occupied a workspace;
determining, with the one or more sensors, that the workspace is no longer occupied by the person;
upon determining that the workspace is no longer occupied by the person, using the one or more sensors for detecting, via an object detection model, one or more objects brought by the person to the workspace;
upon detecting the one or more objects while the workspace remains unoccupied, recording a first timestamp;
comparing a duration of unoccupancy of the workspace since the first timestamp to a maximum unoccupancy duration; and
performing one or more network management actions or one or more workspace management actions in response to the duration of unoccupancy exceeding the maximum unoccupancy duration.

10. The apparatus of claim 9, wherein the one or more network management actions include one or more of: initiating an access control action on one or more network devices or one or more user devices in the workspace to prevent the person from accessing the one or more network devices or the one or more user devices in the workspace, changing a user permission of the person to the one or more network devices or the one or more user devices, preventing the one or more network devices or the one or more user devices in the workspace from receiving one or more network packets, or altering a network resource allocation scheme for data sent to or from the workspace.

11. The apparatus of claim 9, wherein the one or more workspace management actions include one or more of: sending to the person or to a workspace administrator an alert communication to retrieve the one or more objects, sending to the workspace administrator a communication to reassign the workspace, or changing an occupancy state indicator to indicate the workspace is available.

12. The apparatus of claim 9, wherein detecting, via the person detection model, that the person has occupied the workspace comprises:
capturing with at least one video camera a first image of the workspace when the workspace is unoccupied; and
generating, via the person detection model, one or more classifications based on the first image, wherein the one or more classifications include the person.

13. The apparatus of claim 12, wherein determining that the workspace is no longer occupied by the person comprises:
capturing with the at least one video camera a second image of the workspace;
comparing the first image and the second image to determine one or more deviations; and
determining that the workspace is no longer occupied by the person based on the one or more deviations.

14. The apparatus of claim 12, wherein detecting, via the object detection model, the one or more objects brought by the person to the workspace comprises:
capturing with the at least one video camera a second image of the workspace upon determining that the workspace is no longer occupied by the person;
comparing the first image and the second image to determine one or more deviations; and
detecting, via the object detection model, the one or more objects brought by the person based on the one or more deviations.

15. The apparatus of claim 9, wherein determining that the workspace is no longer occupied by the person comprises:
determining that the person has occupied another workspace based on one or more of: an occupancy state indicator, a device pairing status, device usage information, one or more outputs generated by the person detection model or a face recognition algorithm, or proximity pairing information.

16. The apparatus of claim 9, wherein the maximum unoccupancy duration is determined based on an occupancy policy associated with the workspace, and wherein the occupancy policy is based on a workspace type of the workspace determined via a workspace classification model configured to classify the workspace based on one or more of: object detection, room layout analysis, or device usage information, and wherein the workspace classification model includes a large language model, a computer vision model, or a combination thereof.

17. One or more non-transitory computer readable storage media encoded with instructions that, when executed by a processor, cause the processor to:
using one or more sensors positioned to capture activity in a workspace, detect, via a person detection model that operates on output from the one or more sensors, that a person has occupied a workspace;
determine, with the one or more sensors, that the workspace is no longer occupied by the person;
upon determining that the workspace is no longer occupied by the person, use the one or more sensors for detecting, via an object detection model, one or more objects brought by the person to the workspace;
upon detecting the one or more objects while the workspace remains unoccupied, record a first timestamp;
compare a duration of unoccupancy of the workspace since the first timestamp to a maximum unoccupancy duration; and
perform one or more network management actions or one or more workspace management actions in response to the duration of unoccupancy exceeding the maximum unoccupancy duration.

18. The one or more non-transitory computer readable storage media of claim 17, wherein the one or more network management actions include one or more of: initiating an access control action on one or more network devices or one or more user devices in the workspace to prevent the person from accessing the one or more network devices or the one or more user devices in the workspace, changing a user permission of the person to the one or more network devices or the one or more user devices, preventing the one or more network devices or the one or more user devices in the workspace from receiving one or more network packets, or altering a network resource allocation scheme for data sent to or from the workspace.

19. The one or more non-transitory computer readable storage media of claim 17, wherein the one or more workspace management actions include one or more of: sending to the person or to a workspace administrator an alert communication to retrieve the one or more objects, sending to the workspace administrator a communication to reassign the workspace, or changing an occupancy state indicator to indicate the workspace is available.

20. The one or more non-transitory computer readable storage media of claim 17, wherein the maximum unoccupancy duration is determined based on an occupancy policy associated with the workspace, and wherein the occupancy policy is based on a workspace type of the workspace determined via a workspace classification model configured to classify the workspace based on one or more of: object detection, room layout analysis, or device usage information, and wherein the workspace classification model includes a large language model, a computer vision model, or a combination thereof.
